(19) United States
(12) Patent Application Publication
(10) Pub. No.: US 2023/0259635 A1
(43) Pub. Date: Aug. 17, 2023

(54) SYSTEMS AND METHODS FOR PREDICTING DEVELOPMENT OF FUNCTIONAL VULNERABILITY EXPLOITS

(71) Applicants: Arizona Board of Regents on Behalf of Arizona State University, Tempe, AZ (US); University of Maryland, College Park, College Park, MD (US)

(72) Inventors: Tiffany Bao, Tempe, AZ (US); Connor Nelson, Tempe, AZ (US); Zhuoer Lyu, Phoenix, AZ (US); Tudor Dumitras, College Park, MD (US); Octavian Suciu, College Park, MD (US)

(21) Appl. No.: 18/169,674

(22) Filed: Feb. 15, 2023

Related U.S. Application Data
(60) Provisional application No. 63/268,056, filed on Feb. 15, 2022.

(51) Int. Cl. G06F 21/57; G06F 21/55

(52) U.S. Cl. CPC G06F 21/577; G06F 21/552

(57) ABSTRACT

A computer-implemented system incorporates a time-varying view of exploitability in the form of Expected Exploitability (EE) to learn and continuously estimate the likelihood of functional software exploits being developed over time. The system characterizes the noise-generating process systematically affecting exploit prediction, and applies a domain-specific technique (e.g., Feature Forward Correction) to learn EE in the presence of label noise. The system also incorporates timeliness and predictive utility of various artifacts, including new and complementary features from proof-of-concepts, and includes scalable feature extractors. The system is validated on three case studies to investigate the practical utility of EE, showing that the system incorporating EE can qualitatively improve prioritization strategies based on exploitability.

### GOVERNMENT SUPPORT

This invention was made with government support under W911NF-17-1-0370 awarded by the Army Research Office, under HR00112190093 awarded by the Defense Advanced Research Projects Agency (DARPA) and under 2000792 awarded by the National Science Foundation. The government has certain rights in the invention.

### CROSS-REFERENCE TO RELATED APPLICATIONS

This is a U.S. Non-Provisional Patent Application that claims benefit to U.S. Provisional patent application Serial No. 268,056 filed 15 Feb. 2022, which is herein incorporated by reference in its entirety.

### FIELD

The present disclosure generally relates to cybersecurity, and in particular, to a system and associated method for predicting development of functional software vulnerability exploits.

### BACKGROUND

Weaponized exploits have a disproportionate impact on security, as highlighted in 2017 by the WannaCry and NotPetya worms that infected millions of computers worldwide. Their notorious success was in part due to the use of weaponized exploits. The cyber-insurance industry regards such contagious malware, which propagates automatically by exploiting software vulnerabilities, as the leading risk for incurring large losses from cyber attacks. At the same time, the rising bar for developing weaponized exploits pushed black-hat developers to focus on exploiting only 5% of the known vulnerabilities.

It is with these observations in mind, among others, that various aspects of the present disclosure were conceived and developed.

### BRIEF DESCRIPTION OF THE DRAWINGS

FIG. 1A is a simplified diagram showing a system including a general computing device and application for determining expected exploitability of software vulnerabilities;

FIG. 1B is a simplified diagram showing determining expected exploitability of software vulnerabilities using a classification model of the system of FIG. 1A;

FIG. 2 is a graphical representation showing a vulnerability timeline highlighting publication delay for different artifacts and the CVSS Exploitability metric, where a box plot delimits the 25th, 50th and 75th percentiles, and whiskers mark 1.5 times the interquartile range;

FIGS. 3A-3C are a series of graphical representations showing precision (P) and recall (R) for existing severity scores at capturing exploitability, where numerical score values are ordered by increasing severity;

FIG. 4 is a graphical representation showing precision (P) and recall (R) for performance of CVSSv2 at capturing exploitability;

FIGS. 5A and 5B are a pair of graphical representations showing (a) Number of days after disclosure when vulnerability artifacts are first published; and (b) Difference between the availability of exploits and availability of other artifacts, where day differences are in logarithmic scale;

FIG. 6A is a simplified diagram showing classification model generation and training by the system of FIG. 1A;

FIG. 6B is a simplified diagram showing feature extraction by the system of FIG. 1A;

FIG. 6C is a simplified diagram showing training of the classification model of FIG. 6A;

FIG. 6D is a simplified diagram showing deployment of the classification model of FIG. 6C;

FIG. 6E is a simplified diagram showing a streaming environment for continuously updating the classification model of FIG. 6C;

FIG. 6F is a simplified diagram showing updating the classification model of FIG. 6C with new information across a plurality of timeframes;

FIGS. 7A and 7B are a pair of graphical representations showing values of the FC loss function of the output, for different levels of prior \tilde{p}, when y=0 and y=1;

FIGS. 8A and 8B are a pair of graphical representations showing performances of (a) EE compared to baselines; and (b) individual feature categories, evaluated 30 days after disclosure;

FIGS. 9A and 9B are a pair of graphical representations showing (a) Performance of EE compared to constituent subsets of features; and (b) [symbol] evaluated at different points in time;

FIGS. 10A and 10B are a pair of graphical representations showing performance of the classification model when adding Social Media features;

FIGS. 11A and 11B are a pair of graphical representations showing performance of the classification model when considering additional NLP features;

FIG. 12 is a graphical representation showing distribution of EE scores changing between a time of disclosure and within 30 days after disclosure;

FIGS. 13A and 13B are a pair of graphical representations showing performance of the classification model when a fraction of the PoCs are missing;

FIGS. 14A and 14B are a pair of graphical representations showing time-varying AUC when distinguishing exploits published within t days from disclosure (a) for EE and baselines; and (b) simulating earlier exploit availability;

FIG. 15 is a graphical representation showing results of a cyber-warfare game simulation in which the utility of the player is improved by 2,000 points when using EE, note that the player actions are also different in which the CVSS player only attacks when the exploit is leaked (see round 31);

FIGS. 16A-16C are a series of graphical representations showing ROC curves for the corresponding precision-recall curves in FIGS. 8A and 8B;

FIGS. 17A and 17B are a pair of graphical representations showing performance of EE evaluated at different points in time;

FIG. 18 is a simplified diagram showing an example computing device for implementation of the system of FIG. 1A; and

FIGS. 19A-19C are a series of process flow charts showing an example method for determining expected exploitability of a software vulnerability according to the system of FIG. 1A.

Corresponding reference characters indicate corresponding elements among the view of the drawings. The headings used in the figures do not limit the scope of the claims.

### DETAILED DESCRIPTION

Despite significant advances in defenses, exploitability assessments remain elusive because it is unknown which vulnerability features predict exploit development. To prioritize mitigation efforts in the industry, to make optimal decisions in the government's Vulnerabilities Equities Process, and to gain a deeper understanding of the research opportunities to prevent exploitation, each vulnerability's ease of exploitation must be evaluated. For example, expert recommendations for prioritizing patches initially omitted CVE-2017-0144, the vulnerability later exploited by WannaCry and NotPetya. While one can prove exploitability by developing an exploit, it is challenging to establish non-exploitability, as this requires reasoning about state machines with an unknown state space and emergent instruction semantics. This results in a class bias of exploitability assessments, it is uncertain whether or not a “not exploitable” label is accurate.

Assessing exploitability of software vulnerabilities at the time of disclosure is difficult and error-prone, as features extracted via technical analysis by existing metrics are poor predictors for exploit development. Moreover, exploitability assessments suffer from a class bias because negative, or “not exploitable”, labels could be inaccurate. To overcome these challenges, a system and associated methods described herein predicts a likelihood that functional exploits will be developed over time by examining Expected Exploitability (EE). Key to the solution implemented by the system is a time-varying view of exploitability, which is a departure from existing metrics. This allows the system to learn EE for a pre-exploitation software vulnerability using data-driven techniques from artifacts published after disclosure, such as technical write-ups and proof-of-concept exploits, for which novel feature sets are designed.

This view also enables investigation of effects of label biases on classification models, also referred to herein as “classifiers”. A noise-generating process is characterized for exploit prediction. The problem addressed by the system disclosed herein is subject to one of the most challenging types of label noise; as such, the system employs techniques to learn EE in the presence of noise. The present disclosure shows that the system disclosed herein increases precision from 49% to 86% over existing metrics on a dataset of 103,137 vulnerabilities, including two state-of-the-art exploit classifiers, while its precision substantially improves over time. The present disclosure also highlights the practical utility of the system for predicting imminent exploits and prioritizing critical vulnerabilities.

### 1. Introduction

The system disclosed herein addresses the aforementioned challenges in vulnerability assessment through a metric called Expected Exploitability (EE). Instead of deterministically labeling a vulnerability as “exploitable” or “not exploitable”, the system continuously estimates a likelihood over time that a functional exploit will be developed, based on historical patterns for similar vulnerabilities. Functional exploits go beyond proof-of-concepts (PoCs) to achieve the full security impact prescribed by the vulnerability. While functional exploits are readily available for real-world attacks, the system disclosed herein aims to predict their development, which depends on many other factors besides exploitability.

A time-va tying view of exploitability is key, which is a departure from existing vulnerability scoring systems such as CVSS. Existing vulnerability scoring systems are not designed to take into account new information (e.g., new exploitation techniques, leaks of weaponized exploits) that become available after the scores are initially computed. By systematically comparing a range of prior and novel features, it is observed that artifacts published after vulnerability disclosure can be good predictors for the development of exploits, however, their timeliness and predictive utility varies. These observations highlight limitations of prior features and provide a qualitative distinction between predicting functional exploits and related tasks. For example, prior work uses the existence of public PoCs as an exploit predictor. However, PoCs are designed to trigger the vulnerability by crashing or hanging the target application and often are not directly weaponizable; it is observed that this leads to many false positives for predicting functional exploits. In contrast, certain PoC characteristics, such as the code complexity, can be good predictors, because triggering a vulnerability is a necessary step for every exploit, making these features causally connected to the difficulty of creating functional exploits. The present disclosure provides techniques to extract features at scale, from PoC code written in 11 programming languages, which complement and improve upon the precision of previously proposed feature categories. EE can then be learned for a particular software vulnerability from the features using data-driven methods.

However, learning to predict exploitability could be derailed by a biased ground truth. Although prior work had acknowledged this challenge for over a decade, few (if any) attempts have been made to address it. This problem, known in the machine-learning literature as label noise, can significantly degrade the performance of a classifier. The time-varying view of exploitability enables uncovering the root causes of label noise: exploits could be published only after the data collection period ended, which in practice translates to wrong negative labels. This insight enables characterization of the noise-generating process for exploit prediction and propose a technique to mitigate the impact of noise when learning EE.

In experiments on 103,137 vulnerabilities, one implementation of the system disclosed herein significantly outperforms static exploitability metrics and prior state-of-the art exploit predictors, increasing the precision from 49% to 86% one month after disclosure. Using label noise mitigation techniques implemented at a classification model of the system outlined herein, classifier performance is minimally affected even 20% of exploits have missing evidence. Furthermore, by introducing a metric to capture vulnerability prioritization efforts, the present disclosure shows that EE requires only 10 days from disclosure to approach its peak performance. The present disclosure demonstrates practical utility of EE by providing timely predictions for imminent exploits, even when public PoCs are unavailable. Moreover, when employed on scoring 15 critical vulnerabilities, EE places them above 96% of non-critical ones, compared to only 49% for existing metric.

The terms “classifier” and “classification model” may be used interchangeably herein. Likewise, the terms “vulnerability information” and “vulnerability data” may be used interchangeably herein; the terms “software vulnerability” and “vulnerability” may be used interchangeably herein; and the terms “exploit(s)”, “exploit evidence”, and “exploitation evidence” may be used interchangeably herein. Finally, it is also appreciated that the illustrated devices and structures may include a plurality of the same component referenced by the same number. It is appreciated that depending on the context, the description may interchangeably refer to an individual component or use a plural form of the given component(s) with the corresponding reference number.

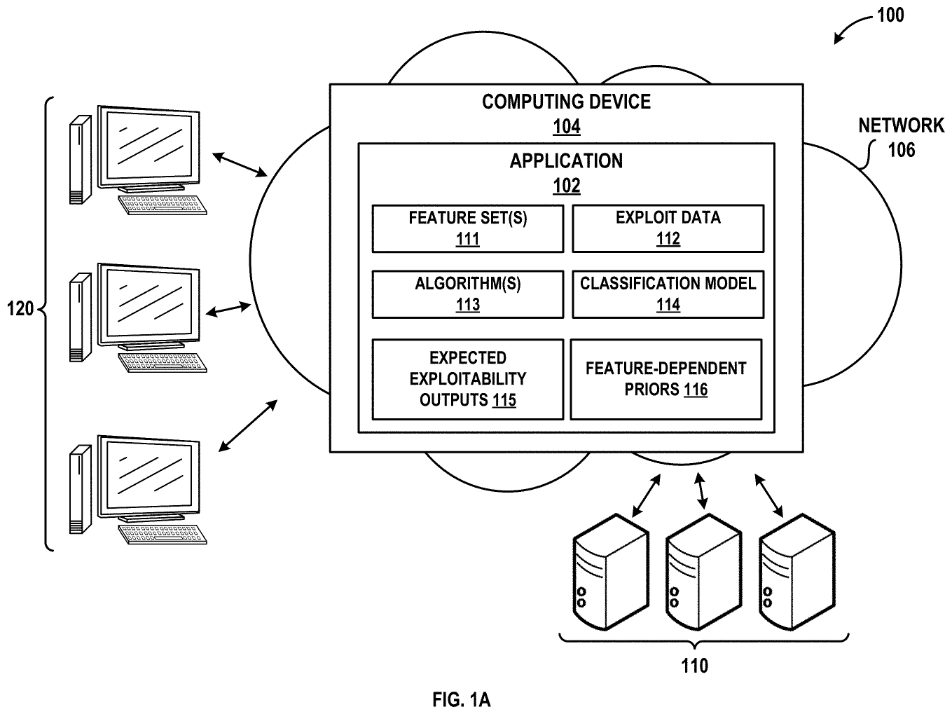

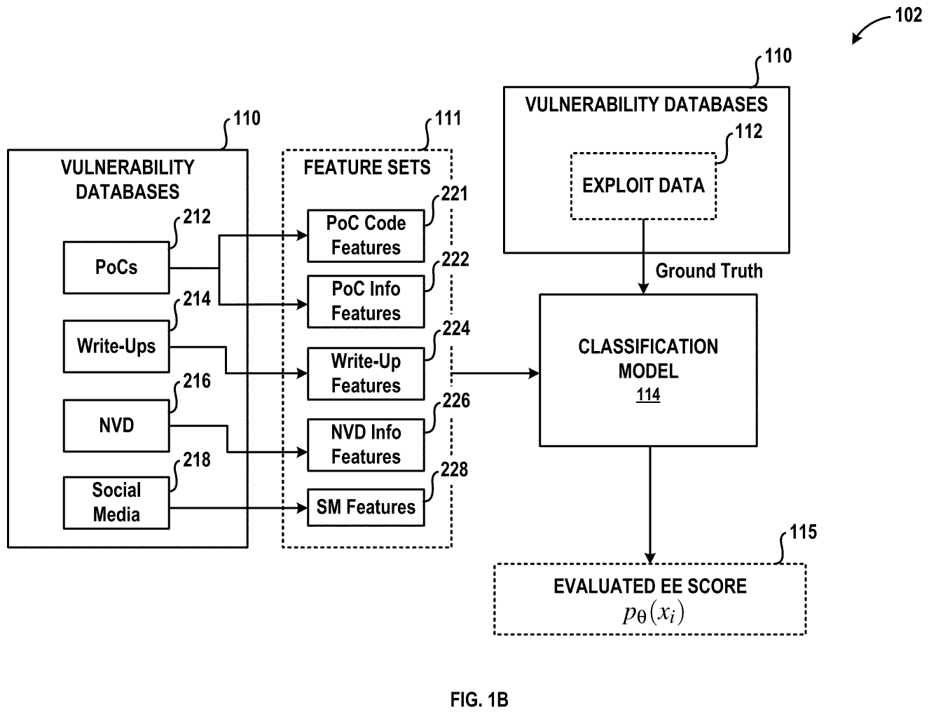

FIGS. 1A and 1B show an overview of an exemplary computer-implemented system (hereinafter “system 100”) for learning and continuously estimating the likelihood of development of functional exploits for a software vulnerability over time. The system 100 can implement functionality defined by an application 102, defining functionality associated with features of a classification model for determining expected exploitability for a software vulnerability over time.

FIG. 1A shows the system 100 including a computing device 104 that can administer, process, and provide access to an application 102 over a network 106 that accesses vulnerability information from a dataset associated with software vulnerabilities from one or more vulnerability databases 110. The information can include proof-of-concepts associated with the software vulnerabilities. The application 102 can extract or otherwise receive feature sets 111 based on the vulnerability information; for training, the application 102 can also assign or otherwise receive exploit data 112 for at least a subset of the vulnerability information. The application 102 can be stored in a memory of the computing device 104, and can include instructions for execution of a plurality of algorithms 113 for feature extraction, training, classification, verification, metrics, among other operations. The application 102 can include a classification model 114 that receives input in the form of the feature sets 111 and generates a set of expected exploitability scores 115, also referred to herein as “EE scores”, fora plurality of software vulnerabilities represented within the vulnerability information, also referred to as “vulnerability dataset” or “vulnerability data”, based on their corresponding feature sets 111. The classification model 114 can include parameters that can be optimized or otherwise updated during training of the classification model 114. In one aspect, the classification model 114 can incorporate feature-dependent priors 116 during training to enable the classification model 114 to account for potential exploitability of software vulnerabilities that lack exploitation evidence based on features of an associated proof-of-concept of the given software vulnerability (e.g., to address the problem of feature-dependent label noise as discussed herein).

FIG. 1B shows the application 102 including feature sets 111 extracted from vulnerability information available within the vulnerability databases 110. Vulnerability information available within the vulnerability databases 110 can include PoC information 212, vulnerability write-ups 214, NVD information 216, and social media information 218; this information can be used by the application 102 to extract features including PoC code features 221 (e.g., characteristics of code present in PoCs), PoC information features 222 (e.g., natural language information present in PoCs), write-up features 224, NVD info features 226, and social media features 228. For training, vulnerability information available within the vulnerability databases 110 can also include labels and other exploit data 112 that provides evidence for actual exploitation of one or more software vulnerabilities within the vulnerability databases 110. In many cases, software vulnerabilities within the vulnerability databases 110 may not have corresponding exploit data; the system disclosed herein considers the possibility that even though a given software vulnerability may not have available evidence of exploitation, exploits targeting the software vulnerability may be in development. The classification model 114 can be trained on a ground truth (e.g., including both feature sets 111 and exploit data 112 for vulnerabilities with confirmed exploits) to evaluate an Expected Exploitability score 115 for a given software vulnerability based on features of the software vulnerability, regardless of whether or not there is evidence of a functional exploit for the software vulnerability.

In summary, contributions of the present disclosure are as follows:
A system that incorporates a time-varying view of exploitability in the form of Expected Exploitability (EE), a metric to learn and continuously estimate the likelihood of functional exploits over time.
The system characterizes the noise-generating process systematically affecting exploit prediction, and applies a domain-specific technique (e.g., Feature Forward Correction) to learn EE in the presence of label noise.
Exploration of timeliness and predictive utility of various artifacts, proposition of new and complementary features from PoCs, and development of scalable feature extractors.
Three case studies are provided to investigate the practical utility of EE, showing that EE can qualitatively improve prioritization strategies based on exploitability.

### 2. Problem Overview

Exploitability is defined herein as the likelihood that a functional exploit, which fully achieves the mandated security impact, will be developed for a vulnerability. Exploitability reflects the technical difficulty of exploit development, and it does not capture the feasibility of lunching exploits against targets in the wild, which is influenced by additional factors (e.g., patching delays, network defenses, attacker choices).

While an exploit represents conclusive proof that a vulnerability is exploitable if it can be generated, proving non-exploitability is significantly more challenging. Instead, mitigation efforts are often guided by vulnerability scoring systems, which aim to capture exploitation difficulty, such as:
NVD CVSS, a mature scoring system with its Exploitability metrics intended to reflect the ease and technical means by which the vulnerability can be exploited. The score encodes various vulnerability characteristics, such as the required access control, complexity of the attack vector and privilege levels, into a numeric value between 0 and 4 (0 and 10 for CVSSv2), with 4 reflecting the highest exploitability.
Microsoft Exploitability Index, a vendor-specific score assigned by experts using one of four values to communicate to Microsoft customers the likelihood of a vulnerability being exploited.
RedHat Severity, similarly encoding the difficulty of exploiting the vulnerability by complementing CVSS with expert assessments based on vulnerability characteristics specific to the RedHat products.

The estimates provided by these metrics are often inaccurate, as highlighted by prior work and by an analysis provided in Section 5 herein. For example, CVE-2018-8174, an exploitable Internet Explorer vulnerability, received a CVSS exploitability score of 1.6, placing it below 91% of vulnerability scores. Similarly, CVE-2018-8440, an exploited vulnerability affecting Windows 7 through 10 was assigned score of 1.8.

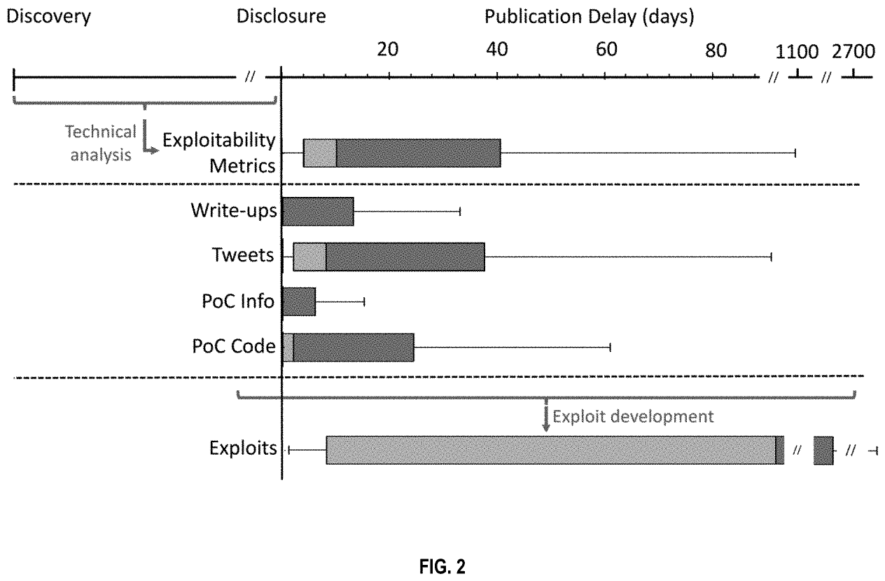

To understand why these metrics are poor at reflecting exploitability, a typical timeline of a vulnerability is highlighted in FIG. 2. The exploitability metrics depend on a technical analysis which is performed before the vulnerability is disclosed publicly, and which considers the vulnerability statically and in isolation.

However, it is observed that public disclosure is followed by the publication of various vulnerability artifacts such as write-ups and PoCs containing code and additional technical information about the vulnerability, and social media discussions around them. These artifacts often provide meaningful information about the likelihood of exploits. For CVE-2018-8174 it was reported that the publication of technical write-ups was a direct cause for exploit development in exploit kits, while a PoC for CVE-2018-8440 has been determined to trigger exploitation in the wild within two days. The examples highlight that existing metrics fail to take into account useful exploit information available only after disclosure and they do not update over time.

FIG. 2 plots the publication delay distribution for different artifacts released after disclosure, according to data analysis described in Section 5. Data shows not only that these artifacts become available soon after disclosure, providing opportunities for timely assessments, but also that static exploitability metrics, such as CVSS, are often not available at the time of disclosure.

Expected Exploitability. The problems mentioned above suggest that the evolution of exploitability over time can be described by a stochastic process. At a given point in time, exploitability is a random variable E encoding the probability of observing an exploit. E assigns a probability 0.0 to the subset of vulnerabilities that are provably unexploitable, and 1.0 to vulnerabilities with known exploits. Nevertheless, the true distribution E generating E is not available at scale, and instead the system can rely on a noisy version E^{train}, as discussed in Section 3. This implies that in practice E has to be approximated from the available data, by determining the likelihood of exploits, which estimates the expected value of exploitability. This measure is referred to herein as Expected Exploitability (EE). EE can be learned from historical data using supervised machine learning and can be used to assess the likelihood of exploits for new vulnerabilities before functional exploits are developed or discovered.

### 3. Challenges

Three challenges are recognized in utilizing supervised techniques for learning, evaluating and using EE.

Extracting features from PoCs. Prior work investigated the existence of PoCs as predictors for exploits, repeatedly showing that they lead to a poor precision. However, PoCs are designed to trigger the vulnerability, a step also required in a functional exploit. As a result, the structure and complexity of the PoC code can reflect exploitation difficulty directly: a complex PoC implies that the functional exploit will also be complex. To fully leverage the predictive power of PoCs, it is necessary to capture these characteristics. While public PoCs have a lower coverage compared to other artifact types, they are broadly available privately because they are often mandated when vulnerabilities are reported.

Extracting features using NLP techniques from prior exploit prediction work is not sufficient, because code semantics differs from that of natural language. Moreover, PoCs are written in different programming languages and are often malformed programs, combining code with free-form text, which limits the applicability of existing program analysis techniques. PoC feature extraction therefore requires text and code separation, and robust techniques to obtain useful code representations.

Understanding and mitigating label noise. Prior work found that the labels available for training have biases, but few attempts were made to link this issue to the problem of label noise. The literature distinguishes two models of non-random label noise, according to the generating distribution: class-dependent and feature-dependent. The former assumes a uniform label flipping probability among all instances of a class, while the latter assumes that noise probability also depends on individual features of instances. If E^{train} is affected by label noise, the test time performance of the classifier could suffer.

By viewing exploitability as time-varying, it becomes immediately clear that exploit evidence datasets are prone to class-dependent noise. This is because exploits might not yet be developed or be kept secret. Therefore, a subset of vulnerabilities believed not to be exploited are in fact wrongly labeled at any given point in time.

In addition, prior work noticed that individual vendors providing exploit evidence have uneven coverage of the vulnerability space (e.g., an exploit dataset from Symantec would not contain Linux exploits because the platform is not covered by the vendor), suggesting that noise probability might be dependent on certain features. The problem of feature-dependent noise is much less studied, and discovering the characteristics of such noise on real-world applications is considered an open problem in machine learning.

Exploit prediction therefore requires an empirical understanding of both the type and effects of label noise, as well as the design of learning techniques to address it.

Evaluating the impact of time-varying exploitability. While some post-disclosure artifacts are likely to improve classification, publication delay might affect their utility as timely predictions. The EE evaluation employed by the system therefore needs to use metrics which highlight potential trade-offs between timeliness and performance. Moreover, the evaluation needs to test whether a classifier can capitalize on artifacts with high predictive power available before functional exploits are discovered, and whether EE can capture the imminence of certain exploits. Finally, there is a need to demonstrate the practical utility of EE over existing static metrics, in real-world scenarios involving vulnerability prioritization.

Goals. One goal is to estimate EE for a broad range of vulnerabilities, by addressing the challenges listed above. Moreover, the system aims to provide estimates that are both accurate and robust: they should predict the development of functional exploits better than the existing scoring systems and despite inaccuracies in the ground truth. One related work uses natural language models trained on underground forum discussions to predict the availability of exploits. In contrast, the system disclosed herein aims to predict functional exploits from public information, a more difficult task as there is a lack of direct evidence of black-hat exploit development. The system further aims to quantify the exploitability of known vulnerabilities objectively, by predicting whether functional exploits will be developed for them.

### 4. Data Collection

This section describes the methods used to collect vulnerability information for development and testing of one example implementation of the system disclosed herein, as well as techniques for discovering various timestamps in the lifecycle of vulnerabilities.

The collected data discussed in this section can be included in the vulnerability databases 110 (FIG. 1B) used to train the classification model 114 (e.g., of system 100 shown in FIG. 1A). Collected data can include PoC data 212, write-ups 214, NVD info 216, and social media info 218, as well as exploit data 112 used within the ground truth.

4.1 Gathering Technical Information

CVEIDs are used to identify vulnerabilities, because it is one of the most prevalent and cross-referenced public vulnerability identification systems. One example collection discussed herein includes data pertaining to vulnerabilities published between January 1999 and March 2020.

Public Vulnerability Information. For development of the system, some information about vulnerabilities targeted by PoCs can be obtained from the National Vulnerability Database (NVD). NVD adds vulnerability information gathered by analysts, including textual descriptions of the issue, product and vulnerability type information, as well as the CVSS score. Nevertheless, NVD only includes high-level descriptions. To build a more complete coverage of the technical information available for each vulnerability, vulnerability information can also include textual information from external references in several public sources. Bugtraq and IBM X-Force Exchange vulnerability databases can be employed to provide additional textual description for the vulnerabilities. Vulners is one database that collects in real time textual information from vendor advisories, security bulletins, third-party bug trackers and security databases. In one investigation, reports that mention more than one CVEID were filtered out, as it would be challenging to determine which particular CVEID was being discussed. In total, one example set of textual information, also referred to herein as write-ups, includes 278,297 documents from 76 sources, referencing 102,936 vulnerabilities. Write-ups, together with the NVD textual information and vulnerability details, provide a broader picture of the technical information publicly available for vulnerabilities.

Proof of Concepts (PoCs). The vulnerability information can include proof-of-concept information, which includes comments and code aimed at demonstrating how to weaponize an exploit or otherwise take advantage of a software vulnerability. However, not all proof-of-concepts are directly weaponizable. A dataset of public PoCs can be collected by scraping ExploitDB, Bugtraq and Vulners, three popular vulnerability databases that contain exploits aggregated from multiple sources. Because there is substantial overlap across these sources, but the formatting of the PoCs might differ slightly, the system can remove duplicates from proof-of-concept information using a content hash that is invariant to such minor whitespace differences. In one example dataset, only 48,709 PoCs were linked to CVEIDs, which correspond to 21,849 distinct vulnerabilities.

Social Media Discussions. Social media discussions about vulnerabilities from Twitter can also be collected; one example dataset included gathering tweets mentioning CVE-IDs between January 2014 and December 2019. 1.4 million tweets for 52,551 vulnerabilities collected by continuously monitoring the Twitter Filtered Stream API. While the Twitter API does not sample returned tweets, short offline periods caused some posts to be lost. By a conservative estimate using the lost tweets which were later retweeted, one example dataset included over 98% of all public tweets about these vulnerabilities.

Exploitation Evidence Ground Truth. Without knowledge of any comprehensive dataset of evidence about developed exploits, exploitation evidence can be aggregated from multiple public sources.

This discussion begins with Temporal CVSS score, which tracks the status of exploits and the confidence in these reports. The Exploit Code Maturity component has four possible values: “Unproven”, “Proof-of-Concept”, “Functional” and “High”. The first two values indicate that the exploit is not practical or not functional, while the last two values indicate the existence of autonomous or functional exploits that work in most situations. Because the temporal score is not updated in NVD, the temporal scores can be collected from two reputable sources: IBM X-Force Exchange threat sharing platform and the Tenable Nessus vulnerability scanner. The labels “Functional” and “High” are used by one implementation of the system as evidence of exploitation, as defined by the official CVSS Specification, obtaining 28,009 exploited vulnerabilities. One example set of exploit information included: evidence of 2,547 exploited vulnerabilities available in three commercial exploitation tools (Metasploit, Canvas and D2); and evidence for 1,569 functional exploits collected by scraping Bugtraq exploit pages and creating NLP rules to extract. Examples of indicative phrases searched using NLP includes: “A commercial exploit is available.”, “A functional exploit was demonstrated by researchers.”.

Exploitation evidence resultant of exploitation in the wild are also collected. One example set of exploitation information included attack signatures from Symantec and Threat Explorer. Labels can be aggregated and extracted from scrapes of sources such as Bugtraq, Tenable, Skybox and AlienVault OTX using NLP rules (matching e.g., “ . . . was seen in the wild.”). In addition, the Contagio dump can also be included to provide a curated list of exploits used by exploit kits. Overall, one example set of exploit information included 4,084 vulnerabilities marked as exploited in the wild.

While exact development time for most exploits is not available, evidence published after more than one year after vulnerability disclosure can be dropped in some cases, simulating a historical setting. In one implementation of the system, a ground truth for training of the classification model included information for 32,093 vulnerabilities known to have functional exploits, therefore reflecting a lower bound for a number of exploits available. This translates to class-dependent label noise in classification, evaluated in Section 7 of the present disclosure.

4.2 Estimating Lifecycle Timestamps

Vulnerabilities are often published in NVD at a later date than their public disclosure. Public disclosure dates for the vulnerabilities in the dataset can be estimated by selecting the minimum date among all write-ups in the collection and the publication date in NVD, in line with prior research. This represents the earliest date when expected exploitability can be evaluated. Estimates for the disclosure dates can be validated by comparing them to two independent prior estimates on vulnerabilities which are also found in the other datasets (about 67%). In one example set of vulnerability information, it was found that the median date difference between the two estimates is 0 days, and the estimates are an average of 8.5 days earlier than prior assessments. Similarly, the time when PoCs are published canbe estimated as the minimum date among all sources that shared them. Accuracy of these dates can be confirmed by verifying the commit history in exploit databases that use version control.

The earliest dates for the emergence of functional exploits and attacks in the wild are estimated to assess whether EE can provide timely warnings. Because the sources of exploit evidence do not share the dates when exploits were developed, these dates are instead estimated from ancillary data. For the exploit toolkits, the earliest date when exploits are reported can be collected from platforms such as Metasploit and Canvas. For exploits in the wild, the dates of first recorded attacks can be drawn from prior work. Timestamps when exploit files were first submitted across all exploited vulnerabilities can be obtained from VirusTotal (a popular threat sharing platform), for. Finally, exploit availability can be estimated as the earliest date among the different sources, excluding vulnerabilities with zero-day exploits. Overall, 10% (3,119) of the exploits had a discoverable date. These estimates could result in label noise, because exploits might sometimes be available earlier, e.g., PoCs that are easy to weaponize. Section 7.3 discusses and measures the impact of such label noise on the EE performance.

4.3 Datasets

Three datasets discussed throughout the present disclosure are employed in one implementation of the system to evaluate EE. DS1 includes all 103,137 vulnerabilities in the collection that have at least one artifact published within one year after disclosure. This is also used to evaluate the timeliness of various artifacts, compare the performance of EE with existing baselines, and measure the predictive power of different categories of features. The second dataset, DS2, includes 21,849 vulnerabilities that have artifacts across all different categories within one year. This is used to compare the predictive power of various feature categories, observe their improved utility overtime, and to test their robustness to label noise. The third dataset, DS3 includes 924 out of the 3,119 vulnerabilities for which the exploit emergence date could be estimated, and which are disclosed during classifier deployment described in Section 6.3 of the present disclosure. These are used to evaluate the ability of EE to distinguish imminent exploit.

### 5. Empirical Observations

The analysis starts with three empirical observations on DS1, which guide the design of the system for determining EE.

Existing scores are poor predictors. First, the effectiveness of three vulnerability scoring systems, described in Section 2, is estimated for predicting exploitability. Because these scores are widely used, these are used as baselines for prediction performance; one goal for EE is to improve this performance substantially. As the three scores do not change over time, a threshold-based decision rule is used to predict that all vulnerabilities with scores greater or equal than the threshold are exploitable. By varying the threshold across the entire score range, and using all the vulnerabilities in the dataset, precision (P) is evaluated as the fraction of predicted vulnerabilities that have functional exploits within one year from disclosure, and recall (R) is evaluated as the fraction of exploited vulnerabilities that are identified within one year.

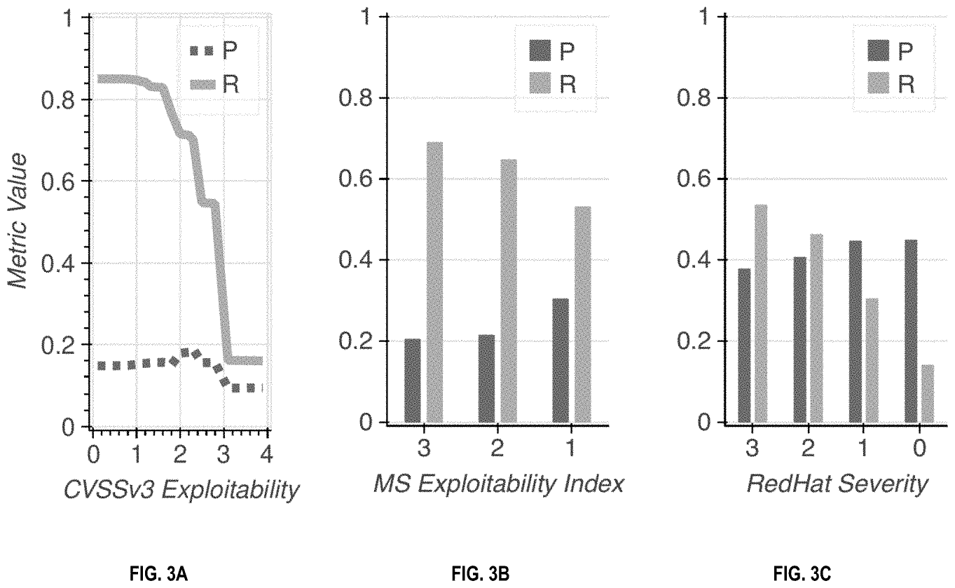

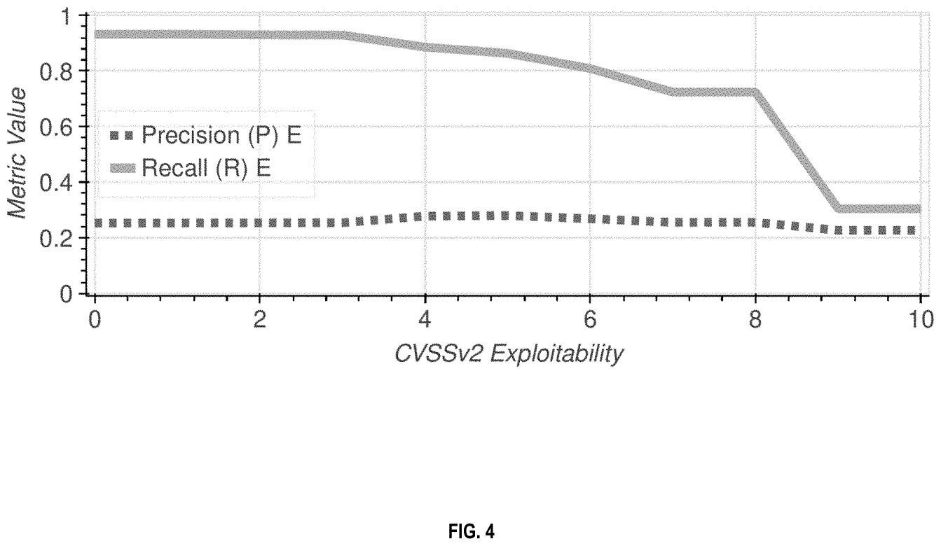

FIG. 3 reports these performance metrics. It is possible to obtain R=1 by marking all vulnerabilities as exploitable, but this affects P because many predictions would be false positives. For this reason, for all the scores, R decreases as the severity threshold for prediction is raised. However, obtaining a high P is more difficult. For CVSSv3 Exploitability, P does not exceed 0.19, regardless of the detection threshold, and some vulnerabilities do not have scores assigned to them. CVSSv2 also exhibits a very poor precision, as illustrated in FIG. 4.

When evaluating the Microsoft Exploitability Index on the 1,100 vulnerabilities for Microsoft products in the dataset disclosed since the score inception in 2008, it the maximum precision achievable is observed to be 0.45. The recall is also lower because the score is only computed on a subset of vulnerabilities.

On the 3,030 vulnerabilities affecting RedHat products, a similar trend for the proprietary severity metric is observed where precision does not exceed 0.45.

These results suggest that the three existing scores predict exploitability with >50% false positives. This is compounded by (1) some scores are not computed for all vulnerabilities, owing to the manual effort required, which intro-duces false negative predictions; (2) the scores do not change, even if new information becomes available; and (3) not all the scores are available at the time of disclosure, meaning that the recall observed operationally soon after disclosure will be lower, as highlighted in the next section.

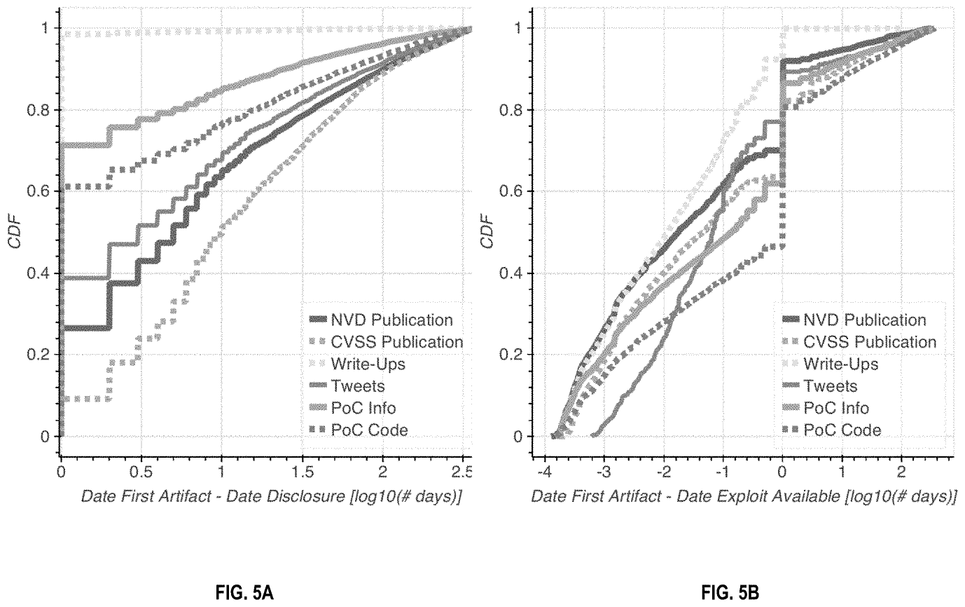

Artifacts provide early prediction opportunities. To assess the opportunities for early prediction, the publication timing for certain artifacts from the vulnerability lifecycle is examined. FIG. 5A plots across all vulnerabilities, the earliest point in time after disclosure when the first write-ups are published, when they are added to NVD, their CVSS and technical analysis are published in NVD, when their first PoCs are released, and when they are first mentioned on Twitter. The publication delay distribution for all collected artifacts is available in FIG. 2.

Write-ups are the most widely available ones at the time of disclosure, suggesting that vendors prefer to disclose vulnerabilities through either advisories or third-party databases. However, many PoCs are also published early: in one estimation, 71% of vulnerabilities have a PoC on the day of disclosure. In contrast, only 26% of vulnerabilities in the dataset are added to NVD on the day of disclosure, and surprisingly, only 9% of the CVSS scores are published at disclosure. This result suggests that timely exploitability assessments require looking beyond NVD, using additional sources of technical vulnerability information, such as the write-ups and PoCs. This observation drives feature engineering discussed in Section 6.1 of the present disclosure.

FIG. 5B highlights the day difference between the dates when the exploits become available and the availability of the artifacts from public vulnerability disclosure. Write-ups became available before the exploits become available for more than 92% of vulnerabilities. One estimate observed that 62% of PoCs are available before this date, while 64% of CVSS assessments are added to NVD before this date. Overall, the availability of exploits is highly correlated with the emergence of other artifacts, indicating an opportunity to infer the existence of functional exploits as soon as, or before, they become available.

Exploit prediction is subject to feature-dependent label noise. Good predictions also require a judicious solution to the label noise challenge discussed in Section 3. The time-varying view of exploitability revealed that the problem is subject to class-dependent noise. However, because evidence about exploits is aggregated from multiple sources, their individual biases could also affect the ground truth. Dependence between all sources of exploit evidence and various vulnerability characteristics is investigated to test for such individual biases. For each source and feature pair, a Chi-squared test for independence is applied, aiming to observe whether it is possible to reject the null hypothesis H₀ that the presence of an exploit within the source is independent of the presence of the feature for the vulnerabilities. Table 1 lists the results for all 12 sources of ground truth, across the most prevalent vulnerability types and affected products in the dataset. The Bonferroni correction and a 0.01 significance level are used for multiple tests. For one implementation, the null hypothesis could be rejected for at least 4 features for each source, indicating that all the sources for ground truth include biases caused by individual vulnerability features. These biases could be reflected in the aggregate ground truth, suggesting that exploit prediction is subject to class- and feature-dependent label noise.

TABLE 1
Evidence of feature-dependent label noise.

| | Functional Exploits | | | | | | Exploits in the Wild | | | | | |
|---|---|---|---|---|---|---|---|---|---|---|---|---|
| | Tenable | X-Force | Metasploit | Canvas | Bugtraq | D2 | Symantec | Contagio | Alienvault | Bugtraq | Skybox | Tenable |
| CWE-79 | ✓ | ✓ | ✓ | ✓ | ✓ | ✓ | ✓ | ✓ | ✓ | ✓ | ✓ | [symbol] |
| CWE-94 | ✓ | ✓ | ✓ | ✓ | ✓ | ✓ | ✓ | ✓ | ✓ | ✓ | ✓ | [symbol] |
| CWE-89 | ✓ | ✓ | ✓ | ✓ | ✓ | [symbol] | ✓ | ✓ | ✓ | ✓ | ✓ | [symbol] |
| CWE-119 | ✓ | ✓ | ✓ | ✓ | ✓ | ✓ | ✓ | ✓ | ✓ | ✓ | ✓ | [symbol] |
| CWE-20 | ✓ | ✓ | ✓ | ✓ | ✓ | ✓ | ✓ | [symbol] | ✓ | [symbol] | ✓ | [symbol] |
| CWE-22 | ✓ | [symbol] | ✓ | [symbol] | [symbol] | ✓ | [symbol] | [symbol] | [symbol] | [symbol] | [symbol] | [symbol] |
| Windows | ✓ | ✓ | ✓ | ✓ | ✓ | [symbol] | ✓ | ✓ | ✓ | ✓ | ✓ | ✓ |
| Linux | ✓ | ✓ | ✓ | ✓ | ✓ | [symbol] | ✓ | ✓ | ✓ | ✓ | ✓ | ✓ |

A ✓ indicates that we can reject the null hypothesis H₀ that evidence of exploits within a source is independent of the feature. Cells with no p-value are <0.001. [symbol]
indicates data missing or illegible when filed

### 6. Computing Expected Exploitability

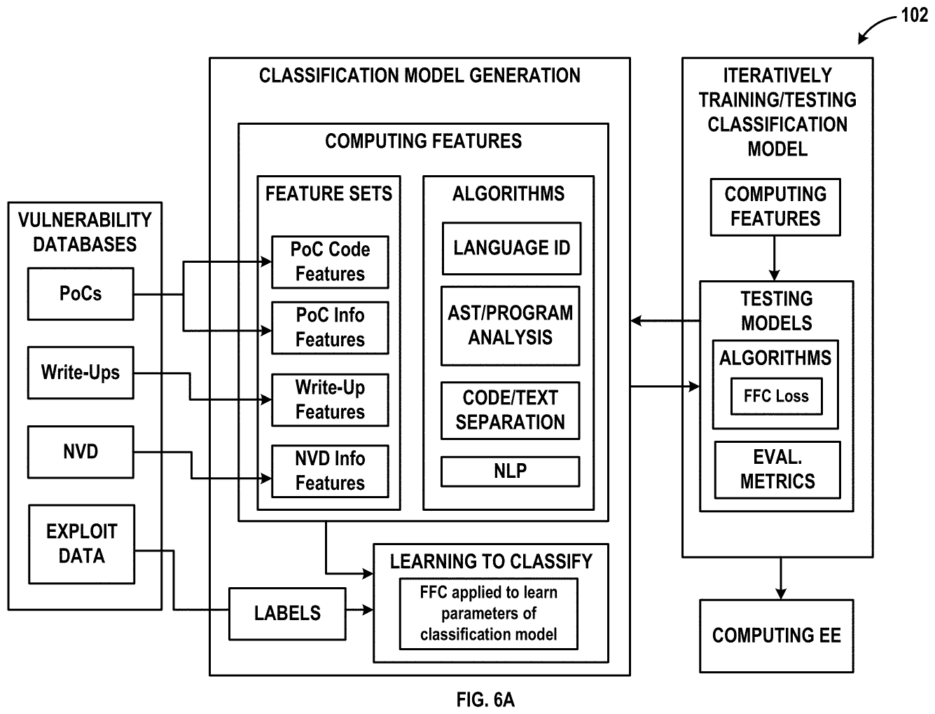

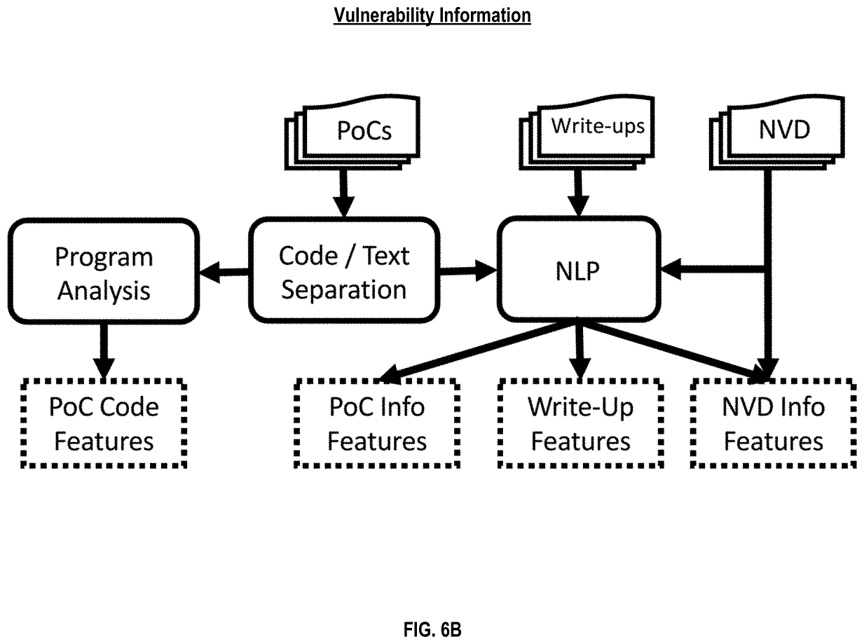

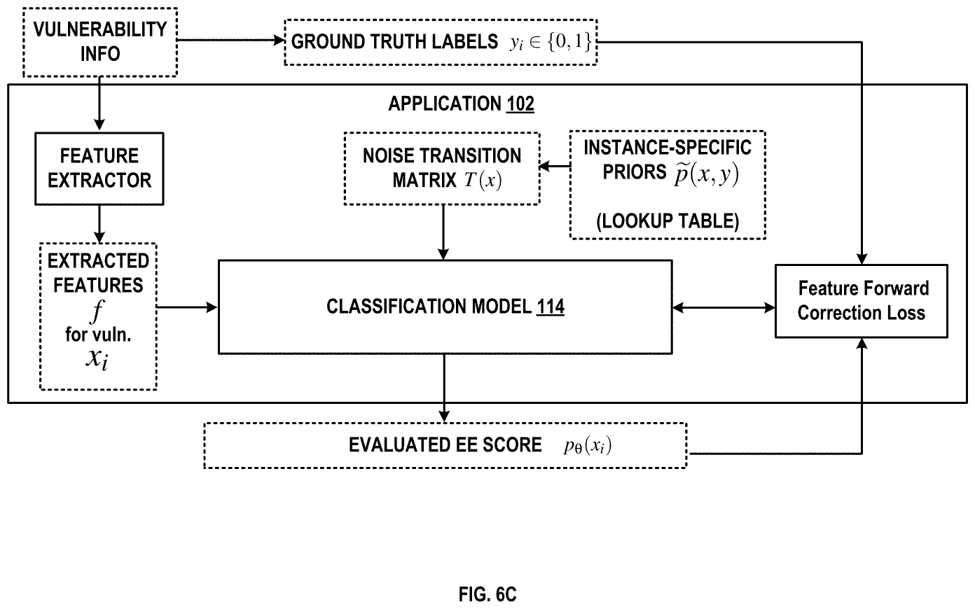

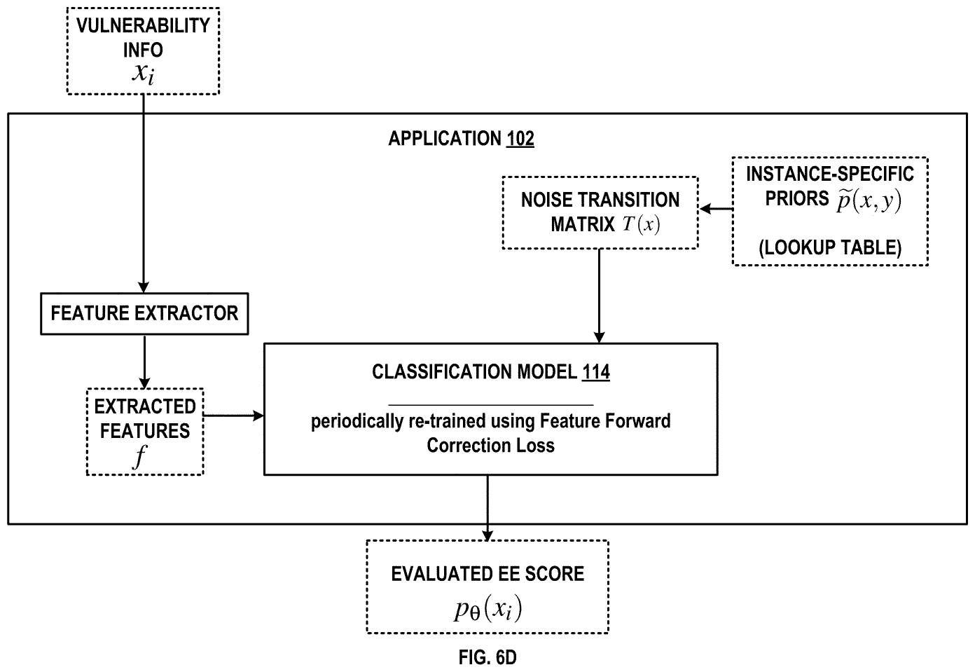

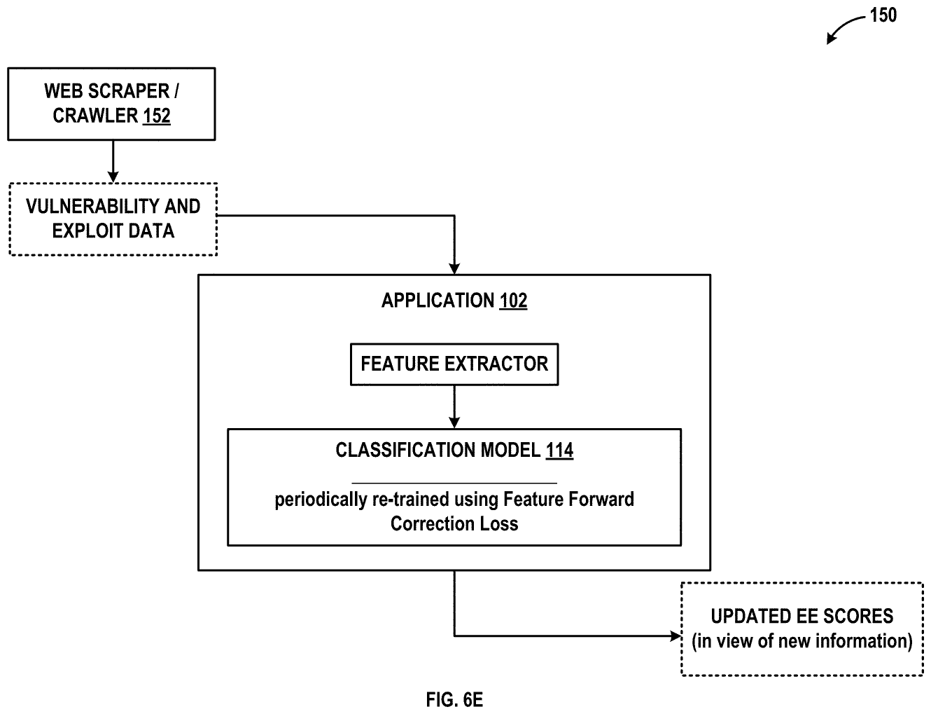

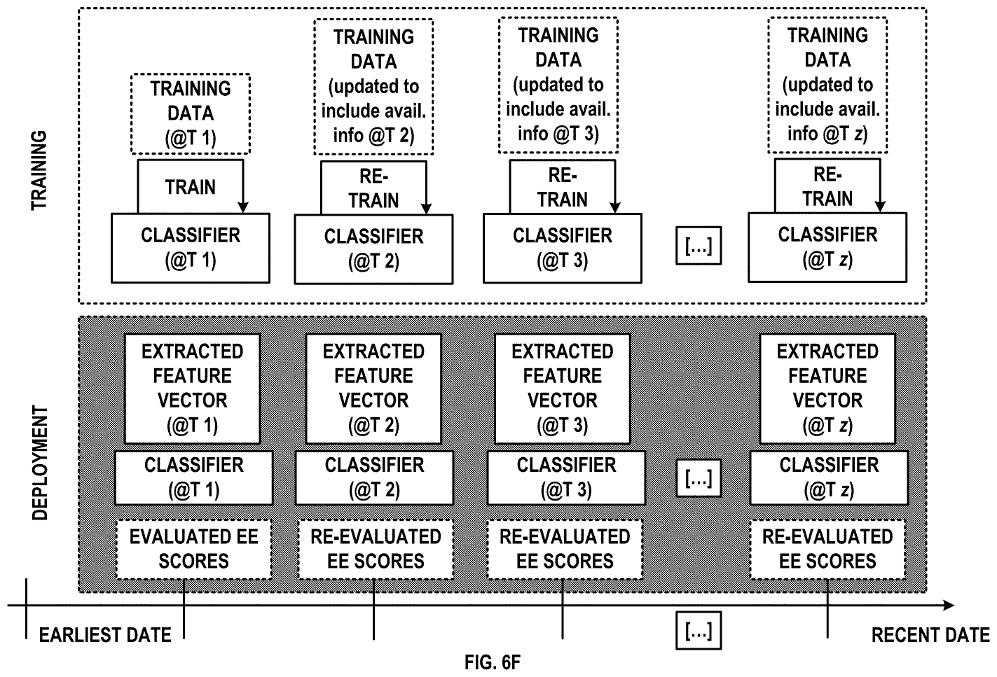

With reference to FIGS. 6A-6F, this section describes the system and application 102 for predicting EE of a given software vulnerability, starting from the design and implementation of feature extraction and classification models of the application 102.

Referring to FIG. 6A, vulnerability information retrieved from vulnerability databases can include (but are not limited to) PoCs, write-ups, NVD information, and exploit data and labels (when available). During generation/initialization of the classification model, the system can compute or otherwise extract feature sets from this information including PoC code features, PoC info features, write-up features and NVD info features; the system can apply several different algorithms and/or methods to extract these feature sets. Importantly, the system can extract PoC code features and PoC info features through programming language identification methods, abstract syntax tree generation and program analysis methods, code/text separation methods (e.g., to separate comments from code), and natural language processing methods.

The classification model of the system can “learn” to classify or otherwise assign an Expected Exploitability score to software vulnerabilities based on the extracted features by observing features and associated exploit data of software vulnerabilities whose information is provided within a training dataset, which can be a subset of the information provided within the vulnerability databases. The classification model can be subjected to an iterative training process in which the system computes or otherwise accesses features (especially PoC code features and PoC information features) of software vulnerabilities whose information is provided within the training dataset, determines an Expected Exploitability score for the software vulnerabilities based on their features, and applies a loss to iteratively adjust parameters of the classification model based on a difference between the Expected Exploitability scores and labels provided within a ground truth of the training dataset. In a primary embodiment, the loss is a Feature Forward Correction loss, a modified version of Forward Correction loss that is formulated to adjust for the problem of feature-dependent label noise discussed above in Section 2 of the present disclosure. The iterative training process may also include other evaluation metrics to ensure effectiveness of the classification model. In some embodiments, as discussed herein, the classification model may be subjected to a historical training and evaluation process in which training data is partitioned based on time availability to simulate the real-world problem of exploits being developed for different vulnerabilities over time.

6.1 Feature Engineering

EE uses features extracted from all vulnerability and PoC artifacts in the datasets, which are summarized in Table 2 and illustrated in FIG. 6B.

TABLE 2
Description of features used. Unigram features are counted before frequency-based pruning.

| | | |
|---|---|---|
| Type | Description | # |

PoC Code (Novel)

| | | |
|---|---|---|
| Length | # characters, loc, sloc | 33 |
| Language | Programming language label | 1 |
| Keywords count | Count for reserved keywords | 820 |
| Tokens | Unigrams from code | 92,485 |
| #_nodes | # nodes in the AST tree | 4 |
| #_internal_nodes | # of internal AST tree nodes | 4 |
| #_leaf_nodes | # of leaves of AST tree | 4 |
| #_identifiers | # of distinct identifiers | 4 |
| #_ext_fun | # of external functions called | 4 |
| #_ext_fun_calls | # of calls to external functions | 4 |
| #_udf | # user-defined functions | 4 |
| #_udf_calls | # calls to user-defined functions | 4 |
| #_operators | # operators used | 4 |
| cyclomatic compl | cyclomatic complexity | 4 |
| nodes_count_* | # of AST nodes for each node type | 316 |
| ctrl_nodes_count_* | # of AST nodes for each control statement type | 29 |
| literal_types_count_* | # of AST nodes for each literal type | 6 |
| nodes_depth_* | Stats depth in tree for each AST node type | 916 |
| branching_factor | Stats # of children across AST | 12 |
| branching_factor_ctrl | Stats # of children within the Control AST | 12 |
| nodes_depth_ctrl_* | Stats depth in tree for each Control AST node type | 116 |
| operator_count_* | Usage count for each operator | 135 |
| #_params_udf | Stats # of parameters for user-defined functions | 12 |

PoC Info (Novel)

| | | |
|---|---|---|
| PoC unigrams | PoCs text and comments | 289,755 |

Write-ups (Prior Work)

| | | |
|---|---|---|
| Write-up unigrams | Write-ups text | 488,490 |

Vulnerability Info (Prior Work)

| | | |
|---|---|---|
| NVD unigrams | NVD descriptions | 103,793 |
| CVSS | CVSSv2 & CVSSv3 components | 40 |
| CWE | Weakness type | 154 |
| CPE | Name of affected product | 10 |

In-the-Wild Predictors (Prior Work)

| | | |
|---|---|---|
| EPSS | Handcrafted | 53 |
| Social Media | Twitter content and statistics | 898,795 |

PoC Code. Intuitively, one of the leading indicators for the complexity of functional exploits is the complexity of PoCs. This is because if triggering the vulnerability requires a complex PoC, an exploit would also have to be complex. Conversely, complex PoCs could already implement functionality beneficial towards the development of functional exploits. This information enables the system to extract features that reflect the complexity of PoC code, by means of intermediate representations that can capture it. The system transforms the code into Abstract Syntax Trees (ASTs), a low-overhead representation which encodes structural characteristics of the code. The system extracts complexity features from the ASTs, including but not limited to: statistics of node types, structural features of the tree, as well as statistics of control statements within the program and the relationship between them. Additionally, the system extracts features for the function calls within the PoCs towards external library functions, which in some cases may be the means through which the exploit interacts with the vulnerability and thereby reflect the relationship between the PoC and its vulnerability. Therefore, the library functions themselves, as well as the patterns in calls to these functions, can reveal information about the complexity of the vulnerability, which might in turn express the difficulty of creating a functional exploit. The system also extracts the cyclomatic complexity from the AST, a software engineering metric which encodes the number of independent code paths in the program. Finally, the system encodes features of the PoC programming language; in one example, these features include form of statistics over the file size and the distribution of language reserved keywords.

It is also observed that the lexical characteristics of the PoC code provide insights into the complexity of the PoC. For example, a variable named “shellcode” in a PoC might suggest that the exploit is in an advanced stage of development. In order to capture such characteristics, the system extracts the code tokens from the entire program, capturing literals, identifiers and reserved keywords, in a set of binary unigram features. Such specific information enables capturing the stylistic characteristics of the exploit, the names of the library calls used, as well as more latent indicators, such as artifacts indicating exploit authorship, which might provide utility towards predicting exploitability. Before training the classifier, the system can filter out lexicon features that appear in less than 10 training-time PoCs, which helps prevent overfitting.

PoC Info. Because a large fraction of PoCs include textual descriptors for triggering the vulnerabilities without actual code, the system extracts features that aim to encode the technical information conveyed by authors of PoCs in the non-code PoCs, as well as comments in code PoCs. The system encodes these features as binary unigrams. Unigrams provide a clear baseline for the performance achievable using NLP. Nevertheless, Section 7.2 of the present disclosure discusses the performance of EE with embeddings, showing that there are additional challenges in designing semantic NLP features for exploit prediction.

Vulnerability Info and Write-ups. To capture the technical information shared through natural language in artifacts, the system extracts unigram features from all the write-ups discussing each vulnerability and the NVD descriptions of the vulnerability. Finally, the system extracts the structured data within NVD that encodes vulnerability characteristics: the most prevalent list of products affected by the vulnerability, the vulnerability types (e.g., CWEID), and all the CVSS Base Score sub-components, using one-hot encoding.

In-the-Wild Predictors. To compare the effectiveness of various feature sets, the system can optionally extract 2 categories proposed in prior predictors of exploitation in the wild. For example, the Exploit Prediction Scoring System (EPSS) proposes 53 features manually selected by experts as good indicators for exploitation in the wild. This set of handcrafted features includes tags reflecting vulnerability types, products and vendors, as well as binary indicators of whether PoC or weaponized exploit code has been published for a vulnerability. Second, from the collection of tweets, the system extracts social media features which reflect the textual description of the discourse on Twitter, as well as characteristics of the user base and tweeting volume for each vulnerability. Unlike previous efforts, one implementation avoided perform feature selection on the unigram features from tweets because in order to compare the utility of Twitter discussions to these from other artifacts. However, these features may have limited predictive utility.

6.2 Feature Extraction

This section describes feature extraction methods and algorithms that can be applied by the system, illustrated in FIG. 6B, and discusses how the system addresses the challenges identified in Section 3.

Code/Text Separation. During development it was found that only 64% of the PoCs in the dataset included any file extension that would enable identification of the programming language. Moreover, 5% of them were found to have conflicting information from different sources. It is observed that many PoCs are first posted online as freeform text without explicit language information. Therefore, a central challenge is to accurately identify their programming languages and whether they contain any code. In one implementation, GitHub Linguist is used to extract the most likely programming languages used in each PoC. GitHub Linguist combines heuristics with a Bayesian classifier to identify the most prevalent language within a file. Nevertheless, GitHub Linguist without modification obtains an accuracy of 0.2 on classifying the PoCs, due to the prevalence of natural language text in PoCs. After modifying the heuristics and retraining the classifier on 42,195 PoCs from ExploitDB that contain file extensions, the accuracy was boosted to 0.95. One main cause of errors is text files with code file extensions, yet these errors have limited impact because of the NLP features extracted from files.

Table 3 lists the number of PoCs in the dataset for each identified language label (the None label represents the cases which the classifier could not identify any language, including less prevalent programming languages not in the label set). It was observed that 58% of PoCs in the dataset are identified as text, while the remaining PoCs are written in a variety of programming languages. Based on this separation, regular expressions are developed to extract the comments from all code files. Following separation, the comments are processed along with the text files using NLP to obtain PoC Info features, while the PoC Code features are obtained using NLP and program analysis.

TABLE 3
Breakdown of the PoCs in our dataset
according to programming language.

| | | # CVEs |
|---|---|---|
| Language | # PoCs | (% exploited) |
| Text | 27743 | 14325 (47%) |
| Ruby | 4848 | 1988 (92%) |
| C | 4512 | 2034 (30%) |
| Perl | 3110 | 1827 (54%) |
| Python | 2590 | 1476 (49%) |
| JavaScript | 1806 | 1056 (59%) |
| PHP | 1040 | 708 (55%) |
| HTML | 1031 | 686 (56%) |
| Shell | 619 | 304 (29%) |
| VisualBasic | 397 | 215 (41%) |
| None | 367 | 325 (43%) |
| C++ | 314 | 196 (34%) |
| Java | 119 | 59 (32%) |

Code Features. Performing program analysis on the PoCs poses a challenge because many of them do not have a valid syntax or have missing dependencies that hinders compilation or interpretation. There is a lack of unified and robust solutions to simultaneously obtain ASTs from code written in different languages. To address this challenge, the system employs heuristics to correct malformed PoCs and parse them into intermediate representations using techniques that provide robustness to errors.

Based on Table 3, one can observe that some languages are likely to have a more significant impact on the prediction performance, based on prevalence and frequency of functional exploits among the targeted vulnerabilities. Given this observation, the implementation is focused on Ruby, C/C++, Perl and Python. Note that this choice does not impact the extraction of lexical features from code PoCs written in other languages.

For C/C++, the Joern fuzzy parser is repurposed for program analysis (as it was previously developed for bug discovery). The tool provides robustness to parsing errors through the use of island grammars and enables successful parsing of 98% of the files.

On Perl, by modifying the existing Compiler::Parser tool to improve its robustness, and employing heuristics to correct malformed PoC files, the parsing success rate is improved from 37% to 83%.

For Python, a feature extractor is implemented based on the ast parsing library, achieving a success rate of 67%. This lower parsing success rate appears to be due to the reliance of the language on strict indentation, which is often distorted or completely lost when code gets distributed through Webpages.

Ruby provides an interesting case study because, despite being the most prevalent language among PoCs, it is also the most indicative of exploitation. It is observed that this is because the dataset includes functional exploits from the Metasploit framework, which are written in Ruby. In one implementation, AST features are extracted for the language using the Ripper library; this implementation is found to successfully parse 96% of the files.

Overall, in one implementation, the system was able to successfully parse 13,704 PoCs associated with 78% of the CVEs that have PoCs with code. Each vulnerability aggregates only the code complexity features of the most complex PoC (in source lines of code) across each of the four languages, while the remaining code features are collected from all PoCs available.

Unigram Features. Textual features are extracted using a standard NLP pipeline which involves tokenizing the text from the PoCs or vulnerability reports, removing non-alphanumeric characters, filtering out English stopwords and representing them as unigrams. For each vulnerability, the PoC unigrams are aggregated across all PoCs, and separately across all write-ups collected within the observation period. In some implementations, when training the classifier, unigrams which occur less than 100 times across the training set can be discarded because they are unlikely to generalize over time and their inclusion did not seem to provide a noticeable performance boost.

6.3 Exploit Predictor Design

With reference to FIG. 6C, the system (e.g., implementing application 102) concatenates all the extracted features into a feature vector, and uses the ground truth about exploit evidence discussed above, to train the classification model 114 which outputs the EE score. One example implementation of the classification model 114 uses a feedforward neural network having 2 hidden layers of size 500 and 100 respectively, with ReLU activation functions. This choice was dictated by two main characteristics of the domain: feature dimensionality and concept drift. First, as there are many potentially useful features with limited coverage, linear models (such as SVM) that tend to emphasize few important features were found to perform worse. Second, deep learning models are believed to be more robust to concept drift and the shifting utility of features, which is a prevalent issue in the exploit prediction task. The architecture was chosen empirically by measuring performance for various settings.

Classifier training. To address the second challenge identified in Section 3, noise robustness is incorporated into the system by exploring several possible loss functions and configurations for the classification model 114. Design choices are driven by two main requirements: (i) providing robustness to both class- and feature-dependent noise, and (ii) providing minimal performance degradation when noise specification is not available. The following analysis is provided to show how several different classification model configurations address the above two requirements. In a preferred embodiment, the classification model 114 is trained using Feature Forward Correction (FFC) discussed herein.

BCE: The binary cross-entropy is the standard, noise-agnostic loss for training binary classifiers. For a set of N examples xᵢ with labels yᵢ ∈{0, 1}, the loss is computed as:

$${L}_{BCE} = - \frac{1}{N} {\sum }_{i = 1}^{N} [ {y}_{i} log ( {p}_{θ} ( {x}_{i} ) ) + ( 1 - {y}_{i} ) log ( 1 - {p}_{θ} ( {x}_{i} ) ) ]$$

where p_{θ}(xᵢ) corresponds to the output probability predicted by the classifier. BCE does not explicitly address requirement (i), but can be used to benchmark noise-aware losses that aim to address requirement (ii).

LR: The Label Regularization, initially proposed as a semi-supervised loss to learn from unlabeled data, has been shown to address class-dependent label noise in malware classification using a logistic regression classifier.

$${L}_{LR} = - \frac{1}{N} {\sum }_{i = 1}^{N} [ {y}_{i} log ( {p}_{θ} ( {x}_{i} ) ) ] - λ KL ( \tilde{p} \vert \vert {\hat{p}}_{θ} )$$

where pθ(xᵢ) corresponds to the output probability predicted by the classifier. The loss function complements the log-likelihood loss over the positive examples with a label regularizer, which is the KL divergence between a noise prior \tilde{p} and the classifier's output distribution over the negative examples \hat{p}_{θ}:

$${\hat{p}}_{θ} = \frac{1}{N} {\sum }_{i = 1}^{N} [ ( 1 - {y}_{i} ) log ( 1 - {p}_{θ} ( {x}_{i} ) ) ]$$

Intuitively, the label regularizer aims to push the classifier predictions on the noisy class towards the expected noise prior \tilde{p}, while the λ hyperparameter controls the regularization strength. This loss is used to observe the extent to which existing noise correction approaches for related security tasks apply to the problem. However, this function was not designed to address requirement (ii) discussed above and, as results will reveal, yields poor performance when applied to this problem.

FC: The Forward Correction loss has been shown to significantly improve robustness to class-dependent label noise in various computer vision tasks. The loss requires a pre-defined noise transition matrix T∈[0,1]^{2×2}, where each element represents the probability of observing a noisy label \tilde{y}ⱼ for a true label yᵢ: Tᵢⱼ=p(\tilde{y}ⱼ|yᵢ). For an instance xᵢ, the log-likelihood is then defined as l_{c}(xᵢ)=−log(T_{0c}(1−p_{θ}(xᵢ))+T_{1c}p_{θ}(xᵢ)) for each class c∈{0,1}. In this case, under the assumption that the probability of falsely labeling non-exploited vulnerabilities as exploited is negligible, the noise matrix can be defined as

$$T = ( \begin{matrix}1 & 0 \\ \tilde{p} & 1 - \tilde{p}\end{matrix} )$$

and the loss reduces to:

$${L}_{FC} = - \frac{1}{N} {\sum }_{i = 1}^{N} [ {y}_{i} log ( ( 1 - \tilde{p} ) {p}_{θ} ( {x}_{i} ) ) + ( 1 - {y}_{i} ) log ( 1 - ( 1 - \tilde{p} ) {p}_{θ} ( {x}_{i} ) ) ]$$

where p_{θ}(xᵢ) corresponds to the output probability predicted by the classifier.

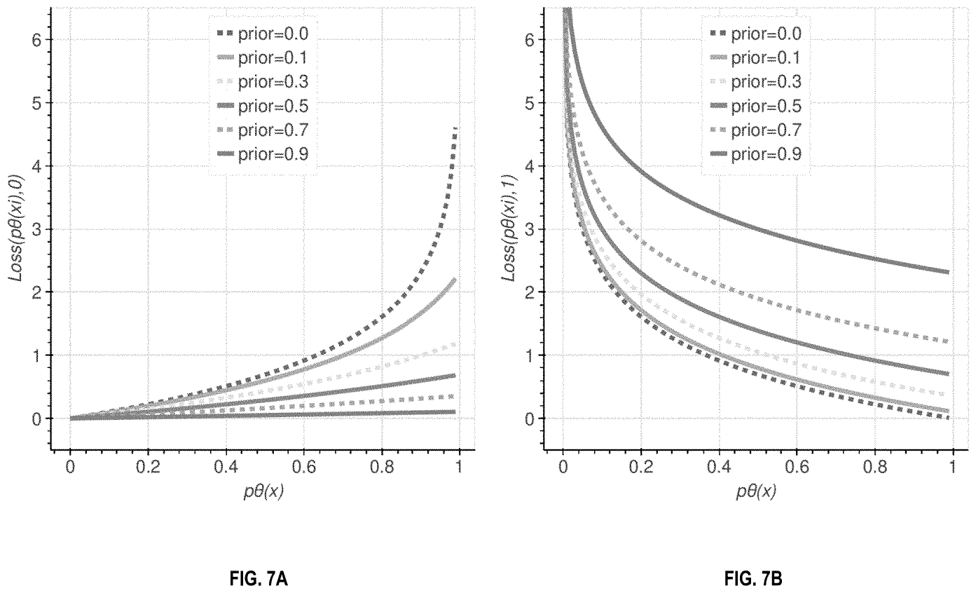

FIGS. 7A and 7B plot the value of the loss function on a single example, for both classes and across the range of priors \tilde{p}. On the negative class, the loss reduces the penalty for confident positive predictions, allowing the classifier to output a higher score for predictions which might have noisy labels. This prevents the classifier from fitting of instances with potentially noisy labels. FC partially addresses requirement (1), being explicitly designed only for class-dependent noise. However, unlike LR, it naturally addresses requirement (ii) because it is equivalent to BCE if \tilde{p}=0.

FFC: To fully address requirement (i), FC is modified to account for feature-dependent noise, a loss function denoted herein as “Feature Forward Correction” (FFC). It is observed that for exploit prediction, feature-dependent noise occurs within the same label flipping template as class-dependent noise. This observation is used to expand the noise transition matrix with instance-specific priors: Tᵢⱼ(x)=p(\tilde{y}ⱼ|x,yᵢ). In this case, the transition matrix becomes:

$$T ( x ) = ( \begin{matrix}1 & 0 \\ \tilde{p} ( x ) & 1 - \tilde{p} ( x )\end{matrix} )$$

Assuming availability of priors only for instances that have certain features f, the instance prior can be encoded as a lookup-table:

$$\tilde{p} ( x , y ) = \{ \begin{matrix}{\tilde{p}}_{f} & if y = 0 and x has f \\ 0 & otherwise\end{matrix}$$

While feature-dependent noise might cause the classifier to learn a spurious correlation between certain features and the wrong negative label, this formulation mitigates the issue by reducing the loss only on the instances that possess these features. Section 7 shows that the task of obtaining feature-specific prior estimates is achievable from a small set of instances; this observation can be used to compare the utility of class-specific and feature-specific noise priors in addressing label noise. When training the classifier, optimal performance was discovered when using an ADAM optimizer for 20 epochs and a batch size of 128, using a learning rate of 5e-6.

As such, with reference to FIG. 6C, the classification model 114 can incorporate the noise transition matrix T(x), where one or more elements of the noise transition matrix includes a feature-dependent prior pf selected based on features of one or more software vulnerabilities of the training data. This enables the classification model to account for potential exploitability of a given software vulnerability based on features of an associated proof-of-concept in cases where the software vulnerability lacks exploitation evidence, such as when an exploit is in development but is not yet publicly reported.

Classifier deployment. Deployment of the classification model 114 is shown in FIG. 6D, where the system 100 receives vulnerability information for a software vulnerability, extracts features of the software vulnerability, and applies the classification model 114 to the features to obtain an evaluated EE score for the software vulnerability.

With reference to FIG. 6E, the application 102 can be placed within a streaming environment 150 that continually updates the vulnerability data (including the exploit data and labels) as the information becomes available. In some embodiments, the streaming environment can include a web scraper or web crawler 152 that records newly-available information about software vulnerabilities for periodic re-training of the classification model 114, allowing the system to continually re-extract features of software vulnerabilities for a new point in time and continually re-train the classification model 114 on updated training data that includes software vulnerabilities and their associated real-world exploit data.

During evaluation of the system, historic performance of the classifier is evaluated by partitioning the dataset into temporal splits, assuming that the classifier is re-trained periodically, on all the historical data available at that time. In one implementation, vulnerabilities disclosed within the last year are omitted when training the classifier because the positive labels from exploitation evidence might not be available until later on. It is estimated that the classifier needs to be retrained every six months, as less frequent re-training would affect performance due to a larger time delay between the disclosure of training and testing instances. During testing, the system operates in a streaming environment in which it continuously collects the data published about vulnerabilities, then recomputes their feature vectors over time and predicts their updated EE score. The prediction for each test-time instance is performed with the most recently trained classifier. During development, to observe how the classifier performs over time, the classifier is trained using the various loss functions and subsequently evaluated on all vulnerabilities disclosed between January 2010 (when 65% of the dataset was available for training) and March 2020.

FIG. 6F shows an example timeline for continual updating of the classification model. At a first timeframe (@T 1), the system can train the classification model using training data available for (@T 1), including ground truth (e.g., exploits data and labels) available for (@T 1), and deploy the classification model on other vulnerability information (e.g., test-case or deployment-case information) available for (@T 1) to obtain evaluated EE scores.

At a second time frame (@T 2), the system can update the training data to include information available for (@T 2), train the classification model on the updated training data, and then deploy the (now-updated) classification model using updated vulnerability information (e.g., test-case or deployment-case information) available for (@T 2) to obtain re-evaluated EE scores. This can include information about new software vulnerabilities that were not available for (@T 1), and can also include new or updated information (including PoC info, exploits data and labels) about software vulnerabilities that were previously included in (@T 1).

Similarly, at a third time frame (@T 3), the system can update the training data to include information available for (@T 3), re-train the classification model on the updated training data, and then deploy the (now-twice-updated) classification model using updated vulnerability information (e.g., test-case or deployment-case information) available for (@T 3) to obtain re-evaluated EE scores. This can include information about new software vulnerabilities that were not available for (@T 2), and can also include new or updated information (including PoC info, exploits data and labels) about software vulnerabilities that were previously included in (@T 2).

This process can be repeated indefinitely to ensure that the classification model is up to date. As new information becomes available for each respective software vulnerability, the EE scores will update to reflect how exploitability of a given software vulnerability changes over time. In the example of FIG. 6F, the process is repeated through a z^{th} time frame (@T z). When evaluating the classification model, data can be partitioned based on time-availability as discussed above to ensure that the EE scores outputted by the system 100 accurately reflect how exploitability of a given software vulnerability changes over time.

### 7. Evaluation

The approach of predicting expected exploitability is evaluated by testing EE on real-world vulnerabilities and answering the following questions, which are designed to address the third challenge identified in Section 3: How effective is EE at addressing label noise? How well does EE perform compared to baselines? How well do various artifacts predict exploitability? How does EE performance evolve over time? Can EE anticipate imminent exploits? Does EE have practicality for vulnerability prioritization?

7.1 Feature-Dependent Noise Remediation

To observe the potential effect of feature-dependent label noise on the classifier, a worst-case scenario is simulated in which a training-time ground truth is missing all the exploits for certain features. The simulation involves training the classifier on dataset DS2, on a ground truth where all the vulnerabilities with a specific feature f are considered not exploited. At testing time, the classifier is evaluated on the original ground truth labels. Table 4 describes the setup for the experiments. 8 vulnerability features are investigated (part of the Vulnerability Info category analyzed in Section 5): the six most prevalent vulnerability types, reflected through the CWE-IDs, as well as the two most popular products: linux and windows. Mislabeling instances with these features results in a wide range of noise: between 5-20% of negative labels become noisy during training.

TABLE 4
Noise simulation setup. We report the % of negative
instances that are noisy, the actual and estimated noise
prior, and the # of instances used to estimate the prior.

| | % | Actual | Est. | # Inst |
|---|---|---|---|---|
| Feature | Noise | Prior | Prior | to Est. |
| CWE-79 | 14% | 0.93 | 0.90 | 29 |
| CWE-94 | 7% | 0.36 | 0.20 | 5 |
| CWE-89 | 20% | 0.95 | 0.95 | 22 |
| CWE-119 | 14% | 0.44 | 0.57 | 51 |
| CWE-20 | 6% | 0.39 | 0.58 | 26 |
| CWE-22 | 8% | 0.39 | 0.80 | 15 |
| Windows | 8% | 0.35 | 0.87 | 15 |
| Linux | 5% | 0.32 | 0.50 | 4 |

All techniques require priors about the probability of noise. The LR and FC approaches require a prior \tilde{p} over the entire negative class. To evaluate an upper bound of their capabilities, a perfect prior us assumed and \tilde{p} is set to match the fraction of training-time instances that are mislabeled. The FFC approach assumes knowledge of the noisy feature f. This assumption is realistic, as it is often possible to enumerate the features that are most likely noisy (e.g., prior work identified linux as a noise-inducing feature due to the fact that the vendor collecting exploit evidence does not have a product for the platform). Besides, FFC requires estimates of the feature-specific priors \tilde{p}_{f}. An operational scenario is assumed where \tilde{p}_{f} is estimated once by manually labeling a subset of instances collected after training. Vulnerabilities disclosed in the first 6 months are used after training for estimating \tilde{p}_{f}; it is required that these vulnerabilities are correctly labeled. Table 4 shows the actual and the estimated priors \tilde{p}_{f}, as well as the number of instances used for the estimation. The number of instances required for estimation is observed to be small, ranging from 5 to 51 across all features f, which demonstrates that setting feature-based priors is feasible in practice. Nevertheless, it is observed that the estimated priors are not always accurate approximations of the actual ones, which might negatively impact FFC's ability to address the effect of noise.

Table 5 lists experimental results. For each classifier, the precision achievable at a recall of 0.8 is reported, as well as the precision-recall AUC. A first observation is that the performance of the vanilla BCE classifier is not equally affected by noise across different features. Interestingly, it is observed that the performance drop does not appear to be linearly dependent on the amount of noise: both CWE-79 and CWE-119 result in 14% of the instances being poisoned, yet only the former inflicts a substantial performance drop on the classifier. Overall, it is observed that the majority of the features do not result in significant performance drops, suggesting that BCE offers a certain amount of built-in robustness to feature-dependent noise, possibly due to redundancies in the feature space which cancel out the effect of the noise.

TABLE 5
Noise simulation results.

| | BCE | | LR | | FC | | FFC | |
|---|---|---|---|---|---|---|---|---|
| Feature | P | AUC | P | AUC | | AUC | P | AUC |
| CWE-79 | 0.58 | 0.80 | 0.67 | 0.79 | 0.58 | 0.81 | 0.75 | 0.87 |
| CWE-94 | 0.81 | 0.89 | 0.71 | 0.81 | 0.81 | 0.89 | 0.82 | 0.89 |
| CWE.89 | 0.61 | 0.82 | 0.57 | 0.74 | 0.61 | 0.82 | 0.81 | 0.89 |
| CWE-119 | 0.78 | 0.88 | 0.75 | 0.83 | 0.78 | 0.87 | 0.81 | 0.89 |
| CWE-20 | 0.81 | 0.89 | 0.72 | 0.82 | 0.80 | 0.88 | 0.82 | 0.90 |
| CWE-22 | 0.81 | 0.89 | 0.69 | 0.80 | 0.81 | 0.89 | 0.83 | 0.90 |
| Windows | 0.80 | 0.88 | 0.71 | 0.81 | 0.80 | 0.88 | 0.83 | 0.90 |
| Linux | 0.81 | 0.89 | 0.71 | 0.81 | 0.81 | 0.89 | 0.82 | 0.90 |

We report the precision at a 0.8 recall (P) and the precision-recall AUC. The pristine BCE classifier performance is 0.83 and 0.90 respectively.

For LR, after performing a grid search for the optimal A parameter set to 1, the BCE performance could not be matched on the pristine classifier. Indeed, the loss was observed as unable to correct the effect of noise on any of the features, suggesting that it is not a suitable choice for the classifier as it does not address any of the two requirements of the classifier.

On features where BCE is not substantially affected by noise, it is observed that FC performs similarly well. However, on CWE-79 and CWE-89, the two features which inflict the most performance drop, FC is not able to correct the noise even with perfect priors, highlighting the inability of the existing technique to capture feature-dependent noise. In contrast, the FFC provides a significant performance improvement. Even for the feature inducing the most degradation, CWE-79, the FFC AUC is restored within 0.03 points of the pristine classifier, although suffering a slight precision drop. On most features, FCC approaches the performance of the pristine classifier, in spite of being based on inaccurate prior estimates.

The results highlight the overall benefits of identifying potential sources of feature-dependent noise, as well as the need for noise correction techniques tailored to the problem. The remainder of this section will use the FFC with \tilde{p}_{f}=0 (which is equivalent to BCE), to observe how the classifier performs in absence of any noise priors.

7.2 Effectiveness of Exploitability Prediction

Next, the effectiveness of the system is evaluated with respect to the three static metrics described in Section 5, as well as two state-of-the-art classifiers from prior work. These two predictors, EPSS, and the Social Media Classifier (SMC), were proposed for exploits in the wild; these are re-implemented and re-trained for the task. EPSS trains an ElasticNet regression model on the set of 53 hand-crafted features extracted from vulnerability descriptors. SMC combines the social media features with vulnerability information features from NVD to learn a linear SVM classifier. Hyperparameter tuning is performed for both baselines and the highest performance across all experiments is reported, obtained using λ=0.001 for EPSS and C=0.0001 for SMC. SMC is trained starting from 2015, as the tweets collection does not begin earlier.

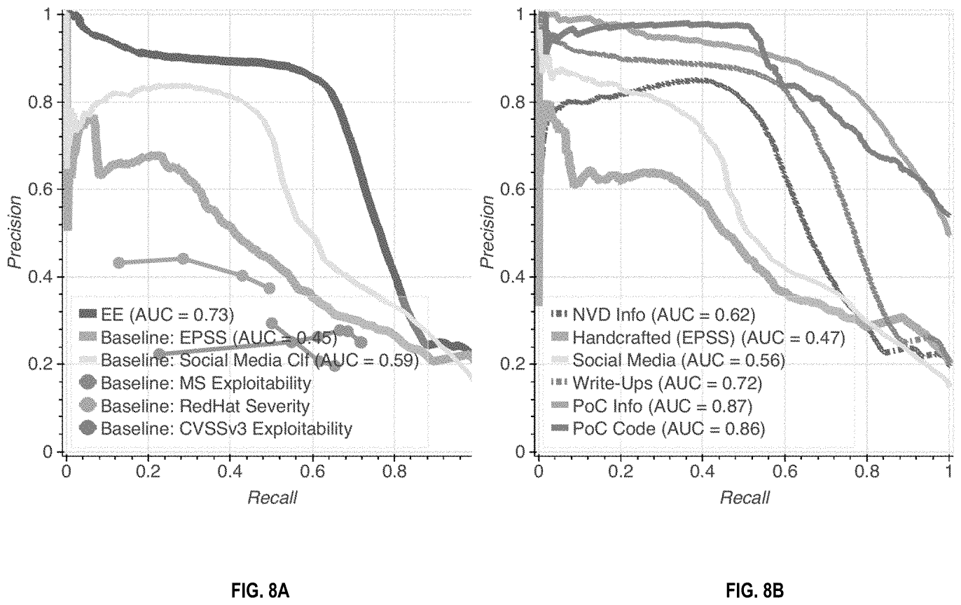

FIG. 8A plots the precision-recall trade-off of the classifiers trained on dataset DS1, evaluated 30 days after the disclosure of test-time instances. It is observed that none of the static exploitability metrics exceed 0.5 precision, while EE significantly outperforms all the baselines. The performance gap is especially apparent for the 60% of exploited vulnerabilities, where EE achieves 86% precision, whereas the SMC, the second-best performing classifier, obtains only 49%. It is observed that for around 10% of vulnerabilities, the artifacts available within 30 days have limited predictive utility, which affects the performance of these classifiers.

EE uses the most informative features. To understand why EE is able to outperform these baselines, FIG. 8B plots the performance of EE trained and evaluated on individual categories of features (i.e., only considering instances which have artifacts within these categories). It is observed that the handcrafted features are the worst performing category, perhaps due to the fact that the 53 features are not sufficient to capture the large diversity of vulnerabilities in the dataset. These features encode the existence of public PoCs, which is often used by practitioners as a heuristic rule for determining which vulnerabilities must be patched urgently. Results suggest that this heuristic provides a weak signal for the emergence of functional exploits, in line with conclusions that PoCs “are not a reliable source of information for exploits in the wild”. Nevertheless, a much higher precision at predicting exploitability can be achieved by extracting deeper features from the PoCs. The PoC Code features provide a 0.93 precision for half of the exploited vulnerabilities, outperforming all other categories. This suggests that code complexity can be a good indicator for the likelihood of functional exploits, although not on all instances, as indicated by the sharp drop in precision beyond the 0.5 recall. A major reason for this drop is the existence of post-exploit mitigation techniques: even if a PoC is complex and includes advanced functionality, defenses might impede successful exploitation beyond denial of service. This highlights how the feature extractor is able to represent PoC descriptions and code characteristics which reflect exploitation efforts. Both the PoC and Write-up features, which EE capitalizes on, perform significantly better than other categories.

Surprisingly, it is observed that social media features are not as useful for predicting functional exploits as they are for exploits in the wild. This finding is reinforced by the results of the experiments conducted below, which show that they do not improve upon other categories. This is because tweets tend to only summarize and repeat information from write-ups, and often do not contain sufficient technical information to predict exploit development. Besides, they often incur an additional publication delay over the original write-ups they quote. Overall, the evaluation highlights a qualitative distinction between the problem of predicting functional exploits and that of predicting exploits in the wild.

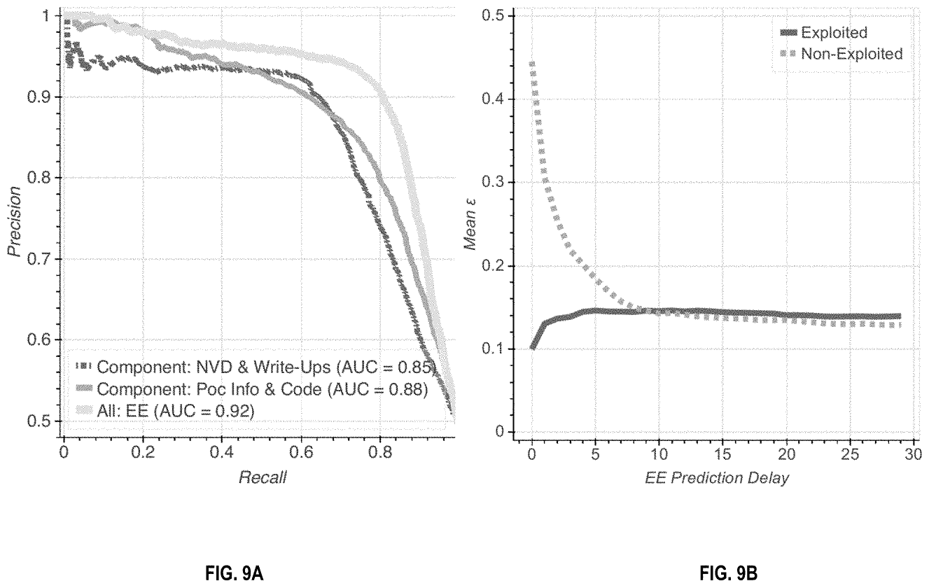

EE improves when combining artifacts. Next, interactions among features on dataset DS2 are examined. FIG. 9A compares the performance of EE trained on all feature sets, with that trained on PoCs and vulnerability features alone. PoC features outperform these from vulnerabilities, while their combination results in a significant performance improvement. The result highlights the two categories complement each other and confirm that PoC features provide additional utility for predicting exploitability. On the other hand, as described below, no added benefit is observed when incorporating social media features into EE; these can be excluded from the final EE feature set.

EE performance improves over time. In order to evaluate the benefits of time-varying exploitability, the precision-recall curves are not sufficient, because they only capture a snapshot of the scores in time. In practice, the EE score would be compared to that of other vulnerabilities disclosed within a short time, based on their most recent scores. Therefore, a metric [symbol] is introduced to compute the performance of EE in terms of the expected probability of error over time.

Fora given vulnerability i, its score EEᵢ(z) computed on date z and its label Dᵢ (Dᵢ=1 if i is exploited and 0 otherwise), the error [symbol] (z, i,S) w.r.t. a set of vulnerabilities S is computed as:

$$( z , i , S ) = \{ \begin{matrix}\frac{‖ {D}_{j} = 0 ⋀ {EE}_{j} ( z ) \geq {EE}_{i} ( z ) \vert j ∈ S \} ‖}{‖ S ] ]} & if {D}_{i} = 1 \\ \frac{‖ {D}_{j} = 1 ⋀ {EE}_{j} ( z ) \leq {EE}_{i} ( z ) \vert j ∈ S \} ‖}{‖ S ] ]} & if {D}_{i} = 0\end{matrix}$$

If i is exploited, the metric reflects the number of vulnerabilities in S which are not exploited but are scored higher than i on date z. Conversely, if i is not exploited, [symbol] computes the fraction of exploited vulnerabilities in S which are scored lower than it. The metric captures the amount of effort spent prioritizing vulnerabilities with no known exploits. For both cases, a perfect score would be 0.0.

For each vulnerability, S is set to include all other vulnerabilities disclosed within t days after its disclosure. FIG. 9B plots the mean [symbol] over the entire dataset, when varying t between 0 and 30, for both exploited and non-exploited vulnerabilities. It is observed that on the day of disclosure, EE already provides a high performance for exploited vulnerabilities: on average, only 10% of the non-exploited vulnerabilities disclosed on the same day will be scored higher than an exploited one. However, in some examples, the score tends to overestimate the exploitability of non-exploited vulnerabilities, resulting in many false positives. This is in line with prior observations that static exploitability estimates available at disclosure have low precision. By following the two curves along the X-axis, the benefits of time-varying features can be observed. Over time, the errors made on non-exploited vulnerabilities decrease substantially: while such a vulnerability is expected to be ranked above 44% exploited ones on the day of disclosure, it will be placed above 14% such vulnerabilities 10 days later. The plot also shows that this sharp performance boost for the non-exploited vulnerabilities incurs a smaller increase in error rates for the exploited class. Great performance improvements after 10 days from disclosure were not necessarily observed. Overall, it is observed that time-varying exploitability contributes to a substantial decrease in the number of false positives, therefore improving precision.

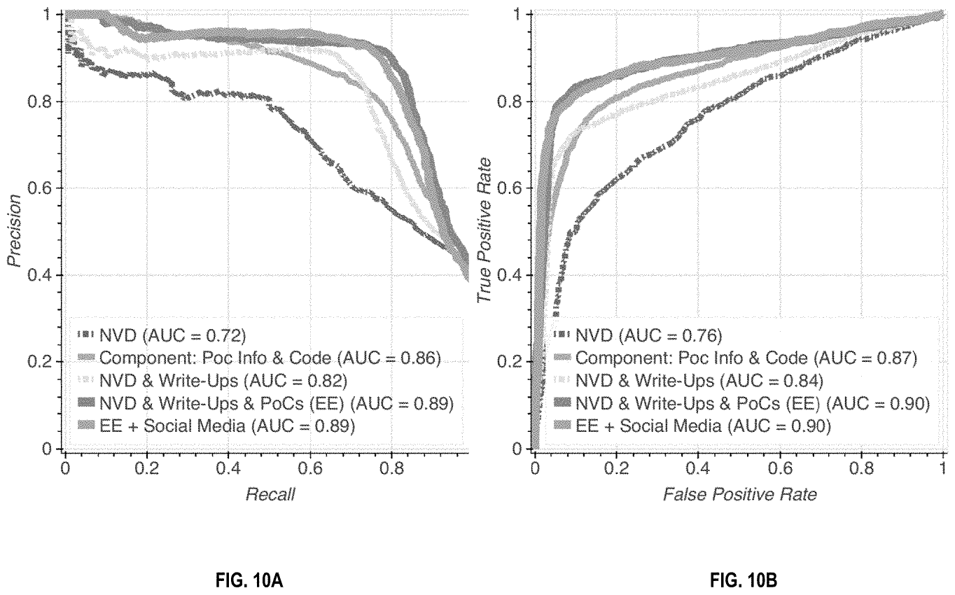

Social Media features do not improve EE. FIGS. 10A and 10B show the effect of adding Social Media features on EE. The results evaluate the classifier trained on DS2, over the time period spanning the tweets collection. It is observed that, unlike the addition of PoC features to these extracted from vulnerability artifacts, these features do not improve the performance of the classifier. This is because tweets generally replicate and summarize the information already included in the technical write-ups that they link to. Because these features convey little extra technical information beyond other artifacts, potentially also incurring an additional publication delay, these features are not incorporated in the final feature set of EE.

Effect of higher-level NLP features on EE. Two alternative representations are investigated for natural language features: T-IDF and paragraph embeddings. T-IDF is a common data mining metric used to encode the importance of individual terms within a document, by means of their frequency within a document, scaled by their inverse prevalence across the dataset. Paragraph embeddings, which were also used by DarkEmbed to represent vulnerability-related posts from underground forums, encode the word features into a fixed-size vector space. In line with prior work, the Doc2Vec model is used to learn the embeddings on the document from the training set. Separate models were used on the NVD descriptions, Write-ups, PoC Info and the comments from the PoC Code artifacts. Grid search is performed for the hyperparameters of the model, and the performance of the best-performing models are reported. The 200-dimensional vectors are obtained from the distributed bag of words (D-BOW) algorithm trained over 50 epochs, using window size of 4, a sampling threshold of 0.001, using the sum of the context words, and a frequency threshold of 2.

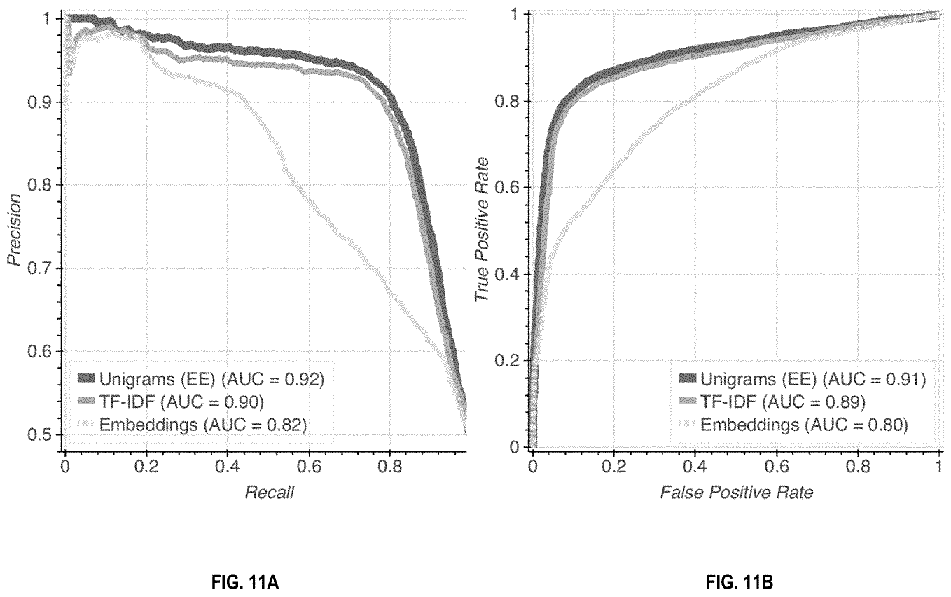

FIGS. 11A and 11B compare the effect of the alternative NLP features on EE. First, it is observed that T-IDF does not improve the performance over unigrams. This suggests that the classifier does not require term frequency to learn the vulnerability characteristics reflected through artifacts, which seems to even hurt performance slightly. This can be explained intuitively, as different artifacts frequently reuse the same jargon for the same vulnerability, but the number of distinct artifacts is not necessarily correlated with exploitability. However, the T-IDF classifier might over-emphasize the numerical value of these features, rather than learning their presence.

Surprisingly, the embedding features result in a significant performance drop, in spite of hyper-parameter tuning attempts. It is observed that the various natural language artifacts in the corpus are long and verbose, resulting in a large number of tokens that need to be aggregated into a single embedding vector. Due to this aggregation and feature compression, the distinguishing words which indicate exploitability might not remain sufficiently expressive within the final embedding vector that the classifier uses as inputs. While the results do not align with the DarkEmbed work finding that paragraph embeddings outperform simpler features, note that Dark-Embed is primarily using posts from underground forums, which are shorter than public write-ups. Overall, results reveal that creating higher level, semantic, NLP features for exploit prediction is a challenging problem, and requires solutions beyond using off-the-shelf tools.

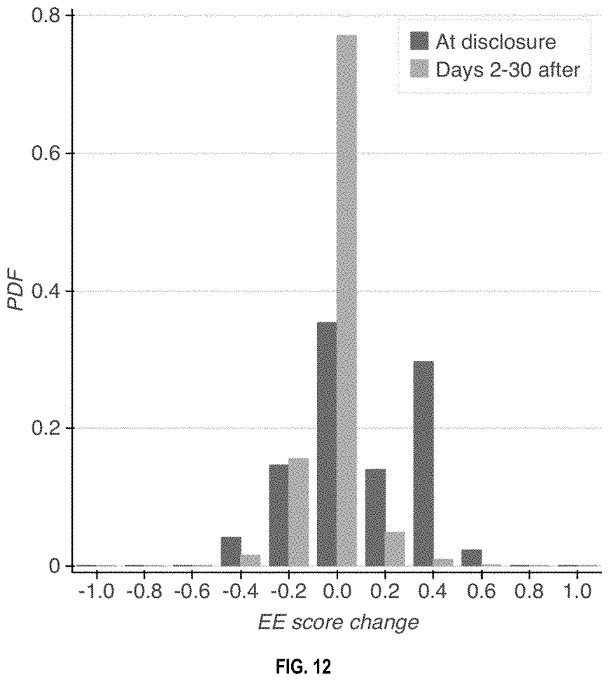

EE is stable over time. To observe how EE is influenced by the publication of various artifacts, the changes in the score of the classifier are observed. FIG. 12 plots, for the entire test set, the distribution of score changes in two cases: at the time of disclosure compared to an instance with no features, and from the second to the 30th day after disclosure, on days where there were artifacts published for an instance. It is observed that at the time of disclosure, the classifier changes drastically, shifting the instance towards either 0.0 or 1.0, while the large magnitude of the shifts indicate a high confidence. However, it is observed that artifacts published on subsequent days have a much different effect. In 79% of cases, published artifacts have almost no effect on changing the classification score, while the remaining 21% of events are the primary drivers of score changes. The two observations enable conclusions that artifacts published at the time of disclosure contain some of the most informative features, and that EE is stable over time, its evolution being determined by few consequential artifacts.

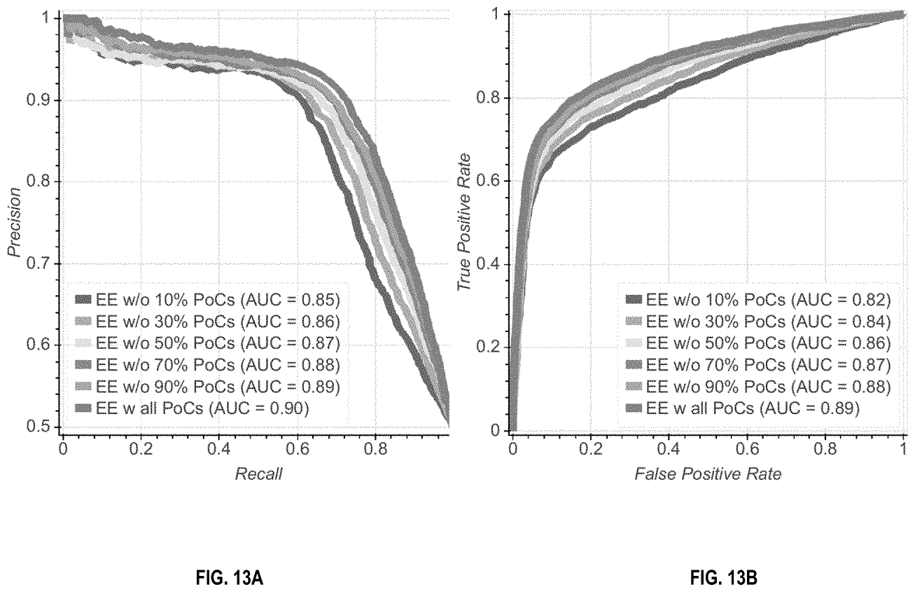

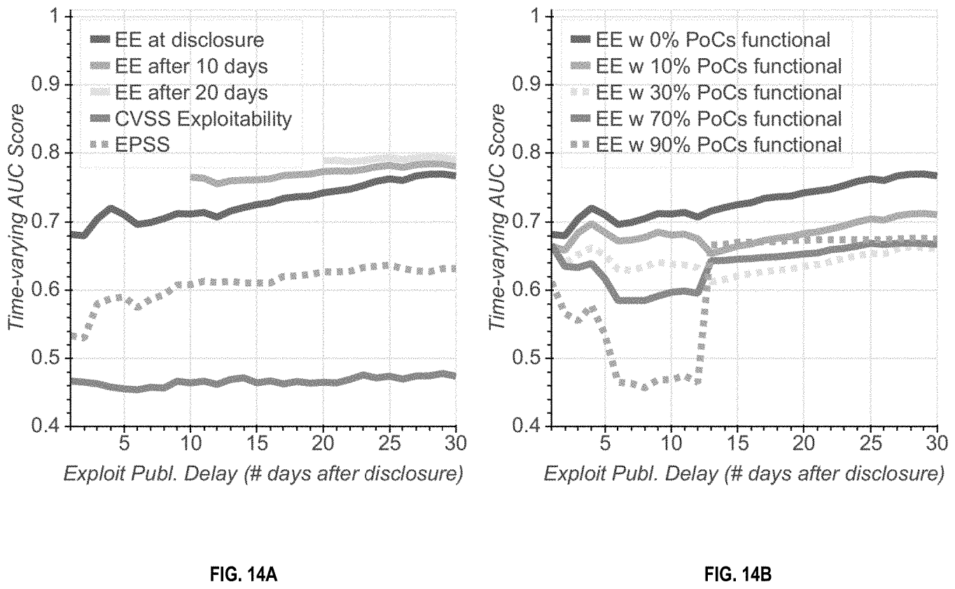

EE is robust to missing exploits. To observe how EE performs when some of the PoCs are missing, a scenario is simulated in which a varying fraction of them are not seen at test-time for vulnerabilities in DS1. The results are plotted in FIGS. 13A and 13B, and highlight that, even if a significant fraction of PoCs is missing, the classifier is able to utilize the other types of artifacts to maintain a high performance.

7.3 Case Studies

This section investigates practical utility of EE through three case studies.

EE for critical vulnerabilities. To understand how well EE distinguishes important vulnerabilities, its performance is measured on a list of recent ones flagged for prioritized re-mediation by FireEye. The list was published on Dec. 8, 2020, after the corresponding functional exploits were stolen. The dataset includes 15 of the 16 critical vulnerabilities.

The classifier is evaluated with respect to how well it prioritizes these vulnerabilities compared to static baselines, using the [symbol] prioritization metric defined in the previous section, which computes the fraction of non-exploited vulnerabilities from a set S that are scored higher than the critical ones. For each of the 15 vulnerabilities, S is set to include all others disclosed within 30 days from it, which represent the most frequent alternatives for prioritization decisions. Table 6 compares the statistics for baselines, and for [symbol] computed on the date critical vulnerabilities were disclosed 0, 10 and 30 days later, as well as one day before the prioritization recommendation was published. CVSS scores are published a median of 18 days after disclosure, and it is observed that the system employing EE already outperforms static baselines based only on the features available at disclosure, while time-varying features improve performance significantly. Overall, one day before the prioritization recommendation is issued, the classifier scores the critical vulnerabilities below only 4% of these with no known exploit. Table 7 shows the performance statistics of the classifier when ISI includes only vulnerabilities published within 30 days of the critical ones and that affect the same products as the critical ones. The result further highlights the utility of EE, as its ranking outperforms baselines and prioritizes the most critical vulnerabilities for a particular product.

TABLE 6
Performance of EE and baselines at prioritizing critical vulnerabilities.

| | | | | [symbol] ^{EE} | [symbol] ^{EE} | [symbol] ^{EE} |
|---|---|---|---|---|---|---|
| | [symbol] ^{CVSS} | [symbol] ^{EPSS} | [symbol] ^{EE} (δ) | (δ + 10) | (δ + 30) | (2020 Dec. 7) |
| Mesu | 0.51 | 0.36 | 0.31 | 0.25 | 0.22 | 0.04 |
| Std | 0.24 | 0.28 | 0.33 | 0.25 | 0.27 | 0.11 |
| Median | 0.35 | 0.40 | 0.22 | 0.12 | 0.10 | 0.00 |

[symbol]

captures the fraction of recent non-exploited vulnerabilities scored higher than critical ones.

TABLE 7
Performance of EE and baselines at prioritizing critical vulnerabilities.

| | | | | [symbol] ^{EE} | [symbol] ^{EE} | [symbol] ^{EE} |
|---|---|---|---|---|---|---|
| | [symbol] ^{CVSS} | [symbol] ^{EPSS} | [symbol] ^{EE} (δ) | (δ + 10) | (δ + 30) | (2020 Dec. 7) |
| Mean | 0.51 | 0.42 | 0.34 | 0.34 | 0.23 | 0.11 |
| Std | 0.39 | 0.32 | 0.40 | 0.40 | 0.30 | 0.26 |
| Medias | 0.43 | 0.35 | 0.00 | 0.04 | 0.14 | 0.00 |

[symbol]

captures the fraction of recent non-exploited vulnerabilities for the same products and scored higher than critical ones.

Table 8 lists the 15 out of 16 critical vulnerabilities in the dataset flagged by FireEye. The table lists the estimated disclosure date, the number of days after disclosure when CVSS was published, and when exploitation evidence emerged. Table 9 includes the per-vulnerability performance of the classifier for all 15 vulnerabilities when ISI includes vulnerabilities published within 30 days of the critical ones. Manual analysis is provided below that shows some of the 15 vulnerabilities in more details by combining EE and [symbol] .

TABLE 8
List of exploited CVE-IDs in our dataset recently
flagged for prioritized remediation. Vulnerabilities
where exploit dates are unknown are marked with ‘?’.

| | | CVSS | Exploit |
|---|---|---|---|
| CVE-ID | Disclosure | Delay | Delay |
| 2019-11510 | 2019 Apr. 24 | 15 | 125 |
| 2018-13379 | 2019 Mar. 24 | 73 | 146 |
| 2018-15961 | 2018 Sep. 11 | 66 | 93 |
| 2019-0604 | 2019 Feb. 12 | 23 | 86 |
| 2019-0708 | 2019 May 14 | 2 | 8 |
| 2019-11580 | 2019 May 06 | 28 | ? |
| 2019-19781 | 2019 Dec. 13 | 18 | 29 |
| 2020-10189 | 2020 Mar. 5 | 1 | 5 |
| 2014-1812 | 2014 May 13 | 1 | 1 |
| 2019-3398 | 2019 Mar. 31 | 22 | 19 |
| 2020-0688 | 2020 Feb. 11 | 2 | 16 |
| 2016-0167 | 2016 Apr. 12 | 2 | ? |
| 2017-11774 | 2017 Oct. 10 | 24 | ? |
| 2018-8581 | 2018 Nov. 13 | 34 | ? |
| 2019-8394 | 2019 Feb. 12 | 10 | 412 |

CVE-2019-0604: Table 9 shows the performance of the classifier on CVE-2019-0604, which improves when more information becomes publicly available. At the disclosure time, there is only one available write-up which yields a low EE because it includes little descriptive features. 23 days later, when NVD descriptions become available, EE decreases even further. However, two technical write-ups on days 87 and 352 result in sharp increases of EE, from 0.03 to 0.22 and to 0.78 respectively. This is because they include detailed technical analyses of the vulnerability, which the classifier interprets as an increased exploitation likelihood.

TABLE 9
The performance of baselines and EE at prioritizing critical
vulnerabilities.

| | | | | | | [symbol] ^{EE} |
|---|---|---|---|---|---|---|
| | | | | | | (2020 |
| CVE-ID | [symbol] ^{CVSS} | [symbol] ^{EPSS} | [symbol] ^{EE} (0) | [symbol] ^{EE} (10) | [symbol] ^{EE} (30) | Dec. 7) |
| 2014-1812 | 0.81 | 0.48 | 0.00 | 0.01 | 0.03 | 0.03 |
| 2016-0167 | 0.97 | 0.15 | 0.79 | 0.50 | 0.13 | 0.04 |
| 2017-11774 | 0.61 | 0.12 | 0.99 | 0.13 | 0.23 | 0.08 |
| 2018-13379 | 0.28 | 0.42 | 0.00 | 0.06 | 0.06 | 0.00 |
| 2018-15961 | 0.25 | 0.55 | 0.39 | 0.46 | 0.41 | 0.00 |
| 2018-8581 | 0.64 | 0.30 | 0.42 | 0.29 | 0.26 | 0.01 |
| 2019-0604 | 0.34 | 0.54 | 0.73 | 0.62 | 0.80 | 0.01 |
| 2019-0708 | 0.30 | 0.07 | 0.00 | 0.00 | 0.00 | 0.00 |
| 2019-11510 | 0.34 | 0.85 | 0.45 | 0.41 | 0.61 | 0.00 |
| 2019-11580 | 0.32 | 0.89 | 0.04 | 0.06 | 0.01 | 0.02 |
| 2019-19781 | 0.36 | 0.01 | 0.09 | 0.13 | 0.00 | 0.00 |
| 2019-3398 | 0.82 | 0.40 | 0.67 | 0.30 | 0.10 | 0.00 |
| 2019-8394 | 0.69 | 0.07 | 0.22 | 0.82 | 0.76 | 0.48 |
| 2020-0688 | 0.77 | 0.62 | 0.00 | 0.00 | 0.00 | 0.00 |
| 2020-10189 | 0.24 | 0.01 | 0.00 | 0.00 | 0.00 | 0.00 |

CVE-2019-8394: [symbol] fluctuates between 0.82 and 0.24 on CVE-2019-8394. At disclosure time, this vulnerability gathers only one write-up, and the classifier outputs a low EE. From disclosure time to day 10, there are two small changes in EE, but at day 10, when NVD information is available, there is a sharp decrease on EE from 0.12 to 0.04. From day 10 to day 365, EE does not change anymore due to no more information added. The decrease of EE at day 10 explains the sharp jump between [symbol] (0) and [symbol] (10) but not the fluctuations after [symbol] (10). This is caused by the EE of other vulnerabilities disclosed around the same period, which the classifier ranks higher than CVE-2019-8394.

CVE-2020-10189 and CVE-2019-0708: These two vulnerabilities receive high EE throughout the entire observation period, due to detailed technical information available at disclosure, which allows the classifier to make confident predictions. CVE-2019-0708 gathers 35 write-ups in total, and 4 of them are available at disclosure. Though CVE-2020-10189 only gathers 4 write-ups in total, 3 of them are available within 1 day of disclosure and contained informative features. These two examples show that the classifier benefits from an abundance of informative features published early on, and this information contribute to confident predictions that remain stable over time.

Results indicate that EE is a valuable input to patching prioritization frameworks, because it outperforms existing metrics and improves over time.

EE for emergency response. Next, performance of the classifier when predicting exploits published shortly after disclosure is evaluated. To this end, the 924 vulnerabilities in DS3 for which obtained exploit publication estimates are examined. To test whether the vulnerabilities in DS3 are a representative sample of all other exploits, a two-sample test is applied under the null hypothesis that vulnerabilities in DS3 and exploited vulnerabilities in DS2 which are not in DS3 are drawn from the same distribution. Because instances are multivariate and the classifier learns feature representations for these vulnerabilities, a technique called Classifier Two-Sample Tests (C2ST) that is designed for this scenario is applied. C2ST repeatedly trains classifiers to distinguish between instances in the two samples and, using a Kolmogorov-Smirnoff test, compares the probabilities assigned to instances from the two to determine whether any statistically significant difference can be established between them. C2ST is applied on the features learned by the classifier (the last hidden layer which includes 100 dimensions), it was found that the null hypothesis that the two samples are drawn from the same distribution (at p=0.01) could not be rejected. Based on this result, one can conclude that DS3 is a representative sample of all other exploits in the dataset. This means that, when considering the features evaluated in the present disclosure, no evidence of biases in DS3 is found.

Performance of EE was measured for predicting vulnerabilities exploited within t days from disclosure. Fora given vulnerability i and EEᵢ(z) computed on date z, the time-varying sensitivity can be computed as Se=P(EEᵢ(z)>c|Dᵢ(t)=1) and specificity Sp=P(EEᵢ(z)≤c|Dᵢ(t)=1), where Dᵢ(t) indicates whether the vulnerability was already exploited by time t. By varying the detection threshold c, the time-varying AUC of the classifier is obtained which reflects how well the classifier separates exploits happening within t days from these happening later on. FIG. 14A plots the AUC for the classifier evaluated on the day of disclosure δ, as well as 10 and 20 days later, for exploits published within 30 days. While the CVSS Exploitability remains below 0.5, EE(δ) constantly achieves an AUC above 0.68. This suggests that the classifiers implicitly learns to assign higher scores to vulnerabilities that are exploited sooner than to these exploited later. For EE(δ+10) and EE(δ+20), in addition to similar trends over time, the benefits of additional features collected in the days after disclosure is observed, which shift the overall prediction performance upward.

The possibility that the timestamps in DS3 may be affected by label noise is also considered. The potential impact of this noise is evaluated with an approach similar to the one in Section 7.1. Scenarios are simulated under the assumption that a percentage of PoCs are already functional, which means that their later exploit-availability dates in DS3 are incorrect. For those vulnerabilities, the exploit availability date is updated to reflect the publication date of these PoCs. This provides a conservative estimate, because the mislabeled PoCs could be in an advanced stage of development, but not yet fully functional, and the exploit-availability dates could also be set too early. Percentages of late timestamps ranging from 10-90% are simulated. FIG. 14B plots the performance of EE(δ) in this scenario, averaged over 5 repetitions. It is observed that even if 70% of PoCs are considered functional, the classifier outperforms the baselines and maintains an AUC above 0.58, Interestingly, performance drops after disclosure and is affected the most on predicting exploits published within 12 days. Therefore, the classifier based on disclosure-time artifacts learns features of easily exploitable vulnerabilities, which are published immediately, but does not fully capture the risk of functional PoC that are published early. This effect can be mitigated by updating EE with new artifacts daily, after disclosure. Overall, the result suggests that EE may be useful in emergency response scenarios, where it is critical to urgently patch the vulnerabilities that are about to receive functional exploits.

EE for vulnerability mitigation. To investigate the practical utility of EE, a case study of vulnerability mitigation strategies is conducted. One example of vulnerability mitigation is cyber warfare, where nations acquire exploits and make decisions based on new vulnerabilities. Existing cyber-warfare research relies on knowledge of exploitability for game strategies. For these models, it is therefore crucial that exploitability estimates are timely and accurate, because inaccuracies could lead to sub-optimal strategies. Because these requirements match design decisions for learning EE, its effectiveness is evaluated in the context of a cyber-game. One example simulates the case of CVE-2017-0144, the vulnerability targeted by the EternalBlue exploit. The game has two players, where Player 1, a government, possesses an exploit that gets stolen, and Player 2, an evil hacker who might know about it could purchase it or re-create it. Game parameters are set to align with the real-world circumstances for the EternalBlue vulnerability, shown in Table 10. In this setup, Player 1's loss of being attacked is significantly greater than Player 2's, because a government needs to take into account the loss for a large population, as opposed to that for a small group or an individual. Both players begin patching once the vulnerability is disclosed, at round 0. The patching rates, which are the cumulative proportion of vulnerable resources being patched over time, are equal for both players and follow the pattern measured in prior work. Another assumption is that the exploit becomes available at t=31, as this corresponds to the delay after which EternalBlue was published.

TABLE 10
Cyber-warfare game simulation parameters.

| | Player 1 | Player 2 |
|---|---|---|
| Loss if attacked | l₁(t) = 5000, ∀t | l₂(t) = 500, ∀t |
| Patching rate | h₁(t) = 1 − 0.8^{t}, ∀t | h₂(t) = 1 − 0.08^{t}, ∀t |

The experiment assumes that Player 1 uses the cyber-warfare model to compute whether they should attack Player 2 after vulnerability disclosure. The calculation requires Player 2's exploitability, which is assigned using two approaches: The CVSS Exploitability score normalized to 1 (which yields a value of 0.55), and the time-varying EE. The classifier outputs an exploitability of 0.94 on the day of disclosure, and updates the exploitability to 0.97 three days later, only to maintain it constant afterwards. The optimal strategy is computed for the two approaches, and compared using the resulting utility for Player 1.

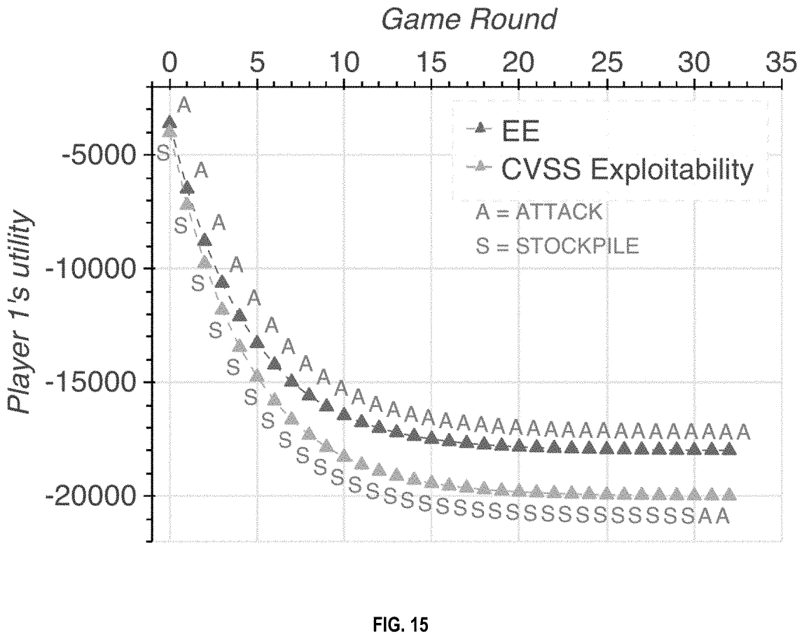

FIG. 15 shows that the strategy associated with EE is preferable over the CVSS one. Although Player 1 will inevitably lose in the game (because they have a much larger vulnerable population), EE improves Player 1's utility by 10%. Interestingly, it is found that EE also changes Player 1's strategy to towards a more aggressive one. This is because EE is updated when more information emerges, which in turn increases the expected exploitability assumed for Player 2. When Player 2 is unlikely to have a working exploit, Player 1 would not attack because that may leak information on how to weaponize the vulnerability, and Player 2 may convert the received exploit to an inverse attack. As Player 2's exploitability increases, Player 1 will switch to attacking because it is likely that Player 2 already possesses an exploit. Therefore, an increasing exploitability pushes Player 1 towards a more aggressive strategy.

### 8. Additional Information

8.1 Evaluation

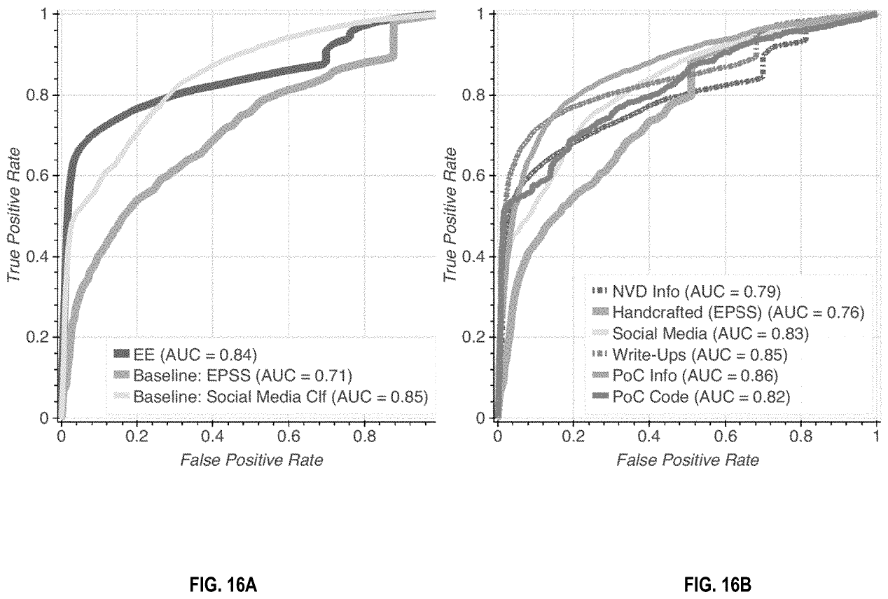

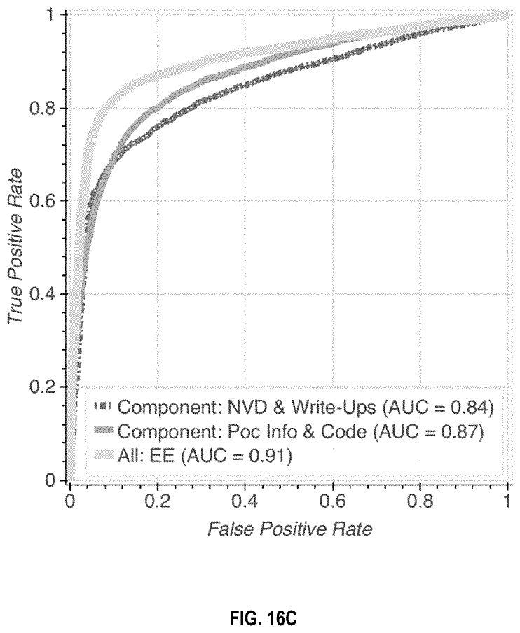

Additional ROC Curves. FIGS. 16A-16C highlight the trade-offs between true positives and false positives in classification.

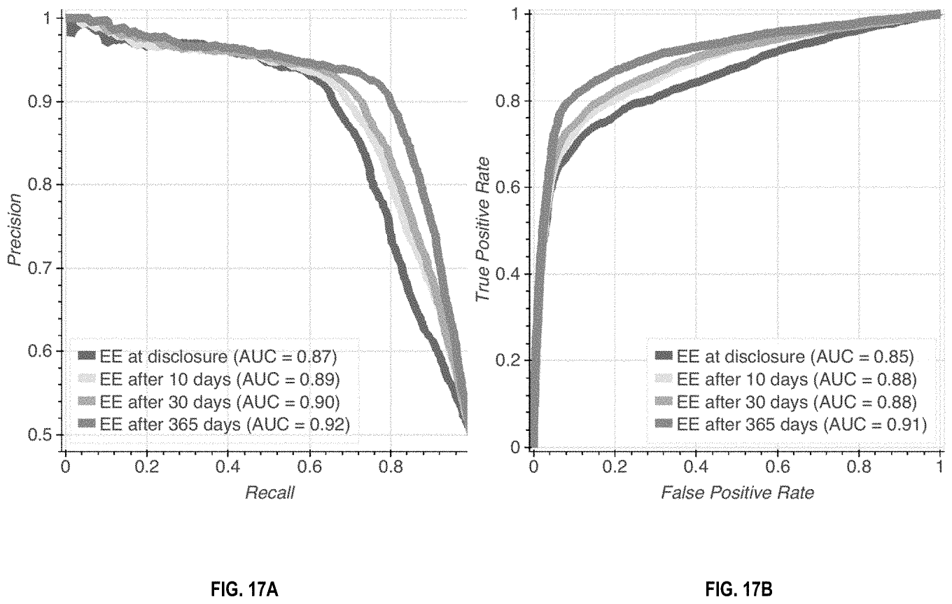

EE performance improves over time. To observe how the classifier performs over time, FIGS. 17A and 17B plot the performance when EE is computed at disclosure, then 10, 30 and 365 days later. The highest performance boost is observed within the first 10 days after disclosure, where the AUC increases from 0.87 to 0.89. Overall, the performance gains are not as large later on: the AUC at 30 days being within 0.02 points of that at 365 days. This suggests that the artifacts published within the first days after disclosure have the highest predictive utility, and that the predictions made by EE close to disclosure can be trusted to deliver a high performance.

8.2 Artifact

One implementation of the system is developed through a Web platform and an API client that allows users to retrieve the Expected Exploitability (EE) scores predicted by the system. This implementation of the system can be updated daily with the newest scores.

The API client for the system is implemented in Python, distributed via Jupyter notebooks in a Docker container, which allows users to interact with the API and download the EE scores to reproduce the main result from this disclosure, in FIGS. 8A and 16A, or explore the performance of the latest model and compare it to the performance of the models from the paper.

8.3 Web Platform

The Web platform exposes the scores of the most recent model, and offers two tools for practitioners to integrate EE in vulnerability or risk management workflow. The Vulnerability Explorer tool allows users to search and investigate basic characteristics of any vulnerability on the platform, the historical scores for that vulnerability as well as a sample of the artifacts used in computing its EE. One use-case for this tool is the investigation of critical vulnerabilities, as discussed in Section 7.3—EE for critical vulnerabilities. The Score Comparison tool allows users to compare the scores across subsets of vulnerabilities of interest. Vulnerabilities can be filtered based on the publication date, type, targeted product or affected vendor. The results are displayed in a tabular form, where users can rank vulnerabilities according to various criteria of interest (e.g., the latest or maximum EE score, the score percentile among selected vulnerabilities, whether an exploit was observed etc.). One use-case for the tool is the discovery of critical vulnerabilities that need to be prioritized soon or for which exploitation is imminent, as discussed in Section 7.3—EE for emergency response.

### 9. Conclusion

By investigating exploitability as a time-varying process, exploitability can be learned using supervised classification techniques and updated continuously. Three challenges associated with exploitability prediction were explored. First, the problem of exploitability prediction is prone to feature-dependent label noise, a type considered by the machine learning community as the most challenging. Second, exploitability prediction needs new categories of features, as it differs qualitatively from the related task of predicting exploits in the wild. Third, exploitability prediction requires new metrics for performance evaluation, designed to capture practical vulnerability prioritization considerations.

### Computer-implemented System

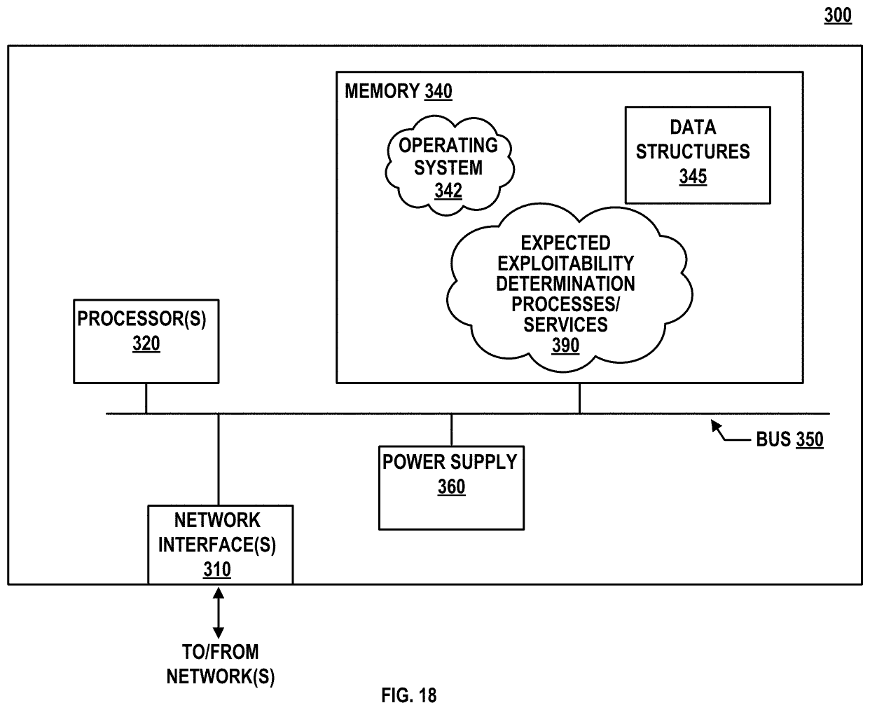

FIG. 18 is a schematic block diagram of an example device 300 that may be used with one or more embodiments described herein, e.g., as a component of system 100 and/or computing device 104 shown in FIG. 1A.

Device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the system 100 and the methods (e.g., those performed by application 102) outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include Expected Exploitability Determination processes/services 390, which can include aspects of methods and/or implementations of various modules implemented by or otherwise within application 102 described herein. Note that while Expected Exploitability Determination processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Expected Exploitability Determination processes/services 390 is shown as a standalone process, those skilled in the art will appreciate that this process may be executed as a routine or module within other processes.

### Methods

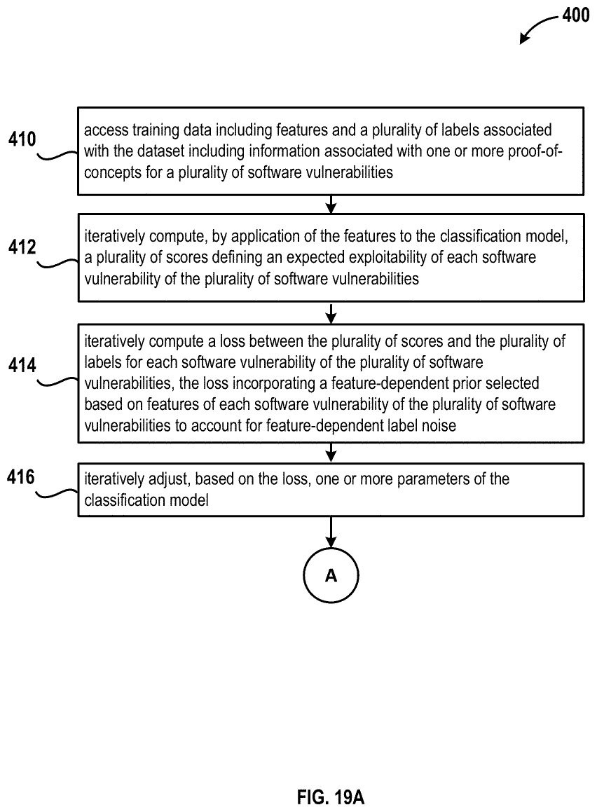

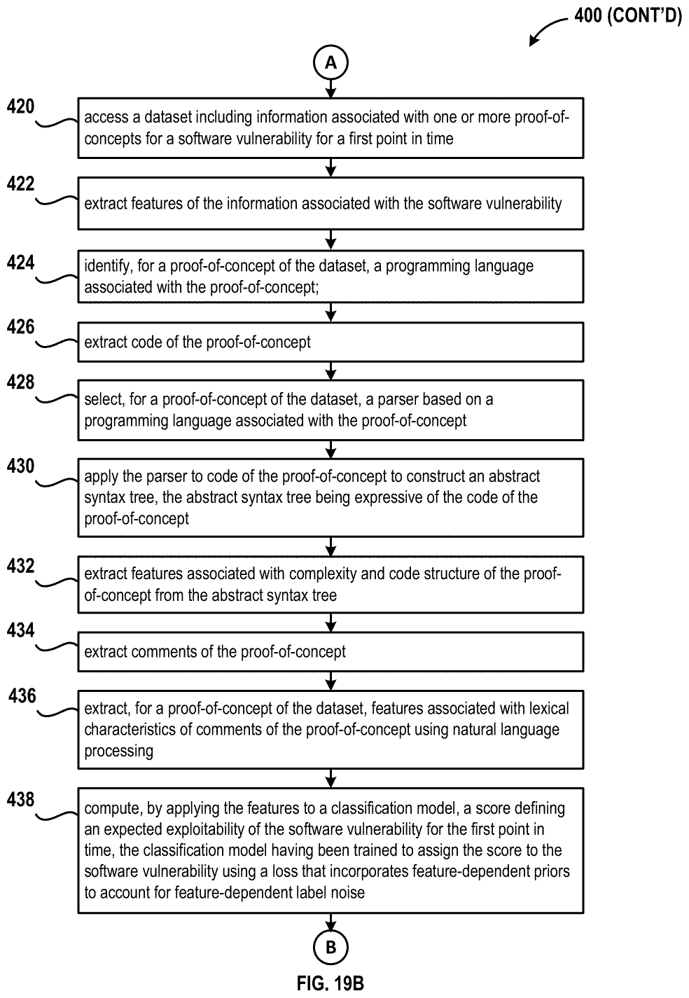

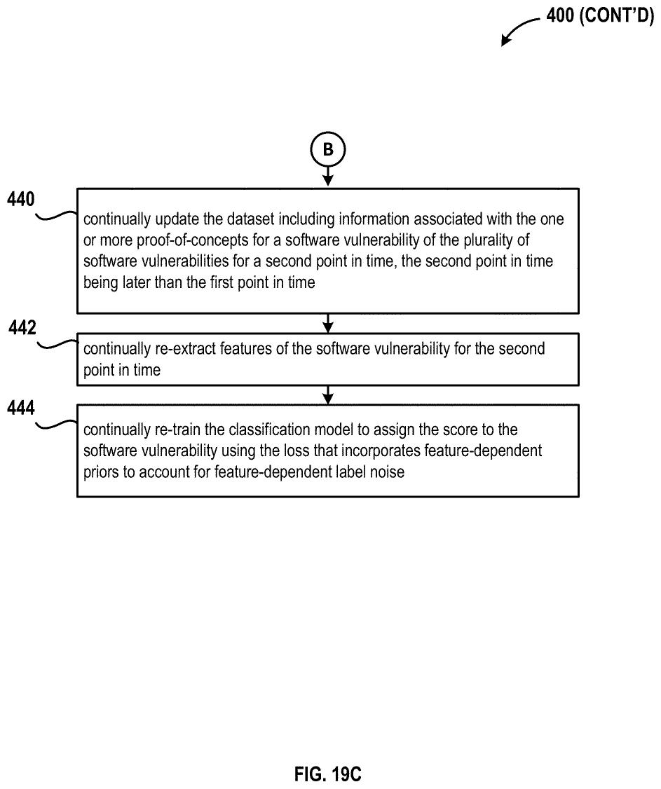

FIGS. 19A-19C show a method 400 for determining expected exploitability of a software vulnerability by the system 100 and methods (including those implemented by application 102 discussed herein).

FIG. 19A shows the method 400 for determining expected exploitability of a software vulnerability. Step 410 of method 400 includes accessing training data including features and a plurality of labels associated with the dataset including information associated with one or more proof-of-concepts for a plurality of software vulnerabilities. Step 412 of method 400 includes iteratively computing, by applying the features to the classification model, a plurality of scores defining an expected exploitability of each software vulnerability of the plurality of software vulnerabilities. Step 414 of method 400 includes iteratively computing a loss between the plurality of scores and the plurality of labels for each software vulnerability of the plurality of software vulnerabilities, the loss incorporating a feature-dependent prior selected based on features of each software vulnerability of the plurality of software vulnerabilities to account for feature-dependent label noise. Step 416 of method 400 includes iteratively adjusting, based on the loss, one or more parameters of the classification model. The method 400 of FIG. 19A continues at Circle A of FIG. 19B.

With reference to FIG. 19B, step 420 of method 400 includes accessing a dataset including information associated with one or more proof-of-concepts for a software vulnerability for a first point in time. Step 422 of method 400 includes extracting features of the information. Step 424 of method 400 includes identifying, for a proof-of-concept of the dataset, a programming language associated with the proof-of-concept. Step 426 of method 400 includes extracting code of the proof-of-concept. Step 428 of method 400 includes selecting, for a proof-of-concept of the dataset, a parser based on a programming language associated with the proof-of-concept. Step 430 of method 400 includes applying the parser to code of the proof-of-concept to construct an abstract syntax tree, the abstract syntax tree being expressive of the code of the proof-of-concept. Step 432 of method 400 includes extracting features associated with complexity and code structure of the proof-of-concept from the abstract syntax tree. Step 434 of method 400 includes extracting comments of the proof-of-concept. Step 436 of method 400 includes extracting, for a proof-of-concept of the dataset, features associated with lexical characteristics of comments of the proof-of-concept using natural language processing. Step 438 of method 400 includes computing, by applying the features to a classification model, a score defining an expected exploitability of the software vulnerability for the first point in time, the classification model having been trained to assign the score to the software vulnerability using a loss that incorporates feature-dependent priors to account for feature-dependent label noise. The method 400 of FIG. 19B continues at Circle B of FIG. 19C.

With reference to FIG. 19C, step 440 of method 400 includes continually updating the dataset including information associated with the one or more proof-of-concepts for a software vulnerability of the plurality of software vulnerabilities for a second point in time, the second point in time being later than the first point in time. Step 442 of method 400 includes continually re-extracting features of the software vulnerability for the second point in time. Step 444 of method 400 includes continually re-training the classification model to assign the score to the software vulnerability using the loss that incorporates feature-dependent priors to account for feature-dependent label noise.

It should be noted that various steps within method 400 may be optional, and further, the steps shown in FIGS. 19A-19C are merely examples for illustration—certain other steps may be included or excluded as desired. Further, while a particular order of the steps is shown, this ordering is merely illustrative, and any suitable arrangement of the steps may be utilized without departing from the scope of the embodiments herein.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, including:
one or more processors in communication with one or more memories, the one or more memories including instructions executable by the one or more processors to:
access a dataset including information associated with one or more proof-of-concepts for a software vulnerability for a first point in time;
extract features of the information associated with the software vulnerability including:
features associated with code structure of the one or more proof-of-concepts; and
features associated with lexical characteristics of the one or more proof-of-concepts;
and
compute, by applying the features to a classification model, a score defining an expected exploitability of the software vulnerability for the first point in time, the classification model having been trained to assign the score to the software vulnerability using a loss that incorporates feature-dependent priors to account for feature-dependent label noise.

2. The system of claim 1, the loss incorporating a noise transition matrix, one or more elements of the noise transition matrix including a feature-dependent prior selected based on features of one or more software vulnerabilities of training data to account for potential exploitability of a given software vulnerability that lacks exploitation evidence based on features of an associated proof-of-concept of the given software vulnerability.

3. The system of claim 2, the feature-dependent prior for a software vulnerability of the training data being zero if an associated class label of the software vulnerability of the training data indicates evidence of exploitation of the software vulnerability of the training data.

4. The system of claim 1, the one or more memories further including instructions executable by the one or more processors to:
access training data including features and a plurality of labels associated with the dataset including information associated with one or more proof-of-concepts for a plurality of software vulnerabilities;
iteratively compute, by applying the features to the classification model, a plurality of scores defining an expected exploitability of each software vulnerability of the plurality of software vulnerabilities;
iteratively compute a loss between the plurality of scores and the plurality of labels for each software vulnerability of the plurality of software vulnerabilities, the loss incorporating a feature-dependent prior selected based on features of each software vulnerability of the plurality of software vulnerabilities to account for feature-dependent label noise; and
iteratively adjust, based on the loss, one or more parameters of the classification model.

5. The system of claim 4, the loss including a noise transition matrix having elements individually adjusted for each respective software vulnerability of the plurality of software vulnerabilities based on respective features of each respective software vulnerability of the plurality of software vulnerabilities.

6. The system of claim 4, the one or more memories further including instructions executable by the one or more processors to:
continually update the dataset including information associated with the one or more proof-of-concepts for a software vulnerability of the plurality of software vulnerabilities for a second point in time, the second point in time being later than the first point in time;
continually re-extract features of the software vulnerability for the second point in time; and
continually re-train the classification model to assign the score to the software vulnerability using the loss that incorporates feature-dependent priors to account for feature-dependent label noise.

7. The system of claim 1, the one or more memories further including instructions executable by the one or more processors to:
identify, for a proof-of-concept of the dataset, a programming language associated with the proof-of-concept;
extract comments of the proof-of-concept; and
extract code of the proof-of-concept.

8. The system of claim 1, the one or more memories further including instructions executable by the one or more processors to:
select, for a proof-of-concept of the dataset, a parser based on a programming language associated with the proof-of-concept;
apply the parser to code of the proof-of-concept to construct an abstract syntax tree, the abstract syntax tree being expressive of the code of the proof-of-concept; and
extract features associated with complexity and code structure of the proof-of-concept from the abstract syntax tree.

9. The system of claim 8, wherein the parser is configured to correct malformations of the code of the proof-of-concept.

10. The system of claim 1, the one or more memories further including instructions executable by the one or more processors to:
extract, for a proof-of-concept of the dataset, features associated with lexical characteristics of comments of the proof-of-concept using natural language processing.

11. A method, comprising:
using one or more processors in communication with one or more memories, the one or more memories including instructions executable by the one or more processors to perform operations including:
accessing a dataset including information associated with one or more proof-of-concepts for a software vulnerability for a first point in time;
extracting features of the information associated with the software vulnerability including:
features associated with code structure of the one or more proof-of-concepts; and
features associated with lexical characteristics of the one or more proof-of-concepts;
and
computing, by applying the features to a classification model, a score defining an expected exploitability of the software vulnerability for the first point in time, the classification model having been trained to assign the score to the software vulnerability using a loss that incorporates feature-dependent priors to account for feature-dependent label noise.

12. The method of claim 11, the loss incorporating a noise transition matrix, one or more elements of the noise transition matrix including a feature-dependent prior selected based on features of one or more software vulnerabilities of training data to account for potential exploitability of a given software vulnerability that lacks exploitation evidence based on features of an associated proof-of-concept of the given software vulnerability.

13. The method of claim 12, the feature-dependent prior for a software vulnerability of the training data being zero if an associated class label of the software vulnerability of the training data indicates evidence of exploitation of the software vulnerability of the training data.

14. The method of claim 11, further comprising:
accessing training data including features and a plurality of labels associated with the dataset including information associated with one or more proof-of-concepts for a plurality of software vulnerabilities;
iteratively computing, by applying the features to the classification model, a plurality of scores defining an expected exploitability of each software vulnerability of the plurality of software vulnerabilities;
iteratively computing a loss between the plurality of scores and the plurality of labels for each software vulnerability of the plurality of software vulnerabilities, the loss incorporating a feature-dependent prior selected based on features of each software vulnerability of the plurality of software vulnerabilities to account for feature-dependent label noise; and
iteratively adjusting, based on the loss, one or more parameters of the classification model.

15. The method of claim 14, the loss including a noise transition matrix having elements individually adjusted for each respective software vulnerability of the plurality of software vulnerabilities based on respective features of each respective software vulnerability of the plurality of software vulnerabilities.

16. The method of claim 14, further comprising:
continually updating the dataset including information associated with the one or more proof-of-concepts for a software vulnerability of the plurality of software vulnerabilities for a second point in time, the second point in time being later than the first point in time;
continually re-extracting features of the software vulnerability for the second point in time; and
continually re-training the classification model to assign the score to the software vulnerability using the loss that incorporates feature-dependent priors to account for feature-dependent label noise.

17. The method of claim 11, further comprising:
identifying, for a proof-of-concept of the dataset, a programming language associated with the proof-of-concept;
extracting comments of the proof-of-concept; and
extracting code of the proof-of-concept.

18. The method of claim 11, further comprising:
selecting, for a proof-of-concept of the dataset, a parser based on a programming language associated with the proof-of-concept;
applying the parser to code of the proof-of-concept to construct an abstract syntax tree, the abstract syntax tree being expressive of the code of the proof-of-concept; and
extracting features associated with complexity and code structure of the proof-of-concept from the abstract syntax tree.

19. The method of claim 18, wherein the parser is configured to correct malformations of the code of the proof-of-concept.

20. The method of claim 11, further comprising:
extracting, for a proof-of-concept of the dataset, features associated with lexical characteristics of comments of the proof-of-concept using natural language processing.
